(19) United States
(12) Patent Application Publication
(10) Pub. No.: US 2003/0195928 A1
(43) Pub. Date: Oct. 16, 2003

(54) System and method for providing reference information to allow chat users to easily select a chat room that fits in with his tastes

(76) Inventors: Satoru Kamijo, Tokyo (JP); Tetsuo Takakura, Tokyo (JP)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/122,420

(22) Filed: Apr. 16, 2002

(51) Int. Cl. G06F 15/16

(52) U.S. Cl. 709/204

(57) ABSTRACT

A chat system of the present invention, which is constituted by a server device and client devices that are connected to each other through the Internet so as to communicate with each other, is provided with a comment contents extraction processing section which extracts the contents of a comment in each of chat rooms; a comment contents DB for storing the contents of the comment thus extracted, for each of the chat rooms or for each of the users; a retrieval processing section which generates reference information used as reference when the user makes a selection from chat rooms, based upon the contents of comments; and a communication control interface for informing the user of this reference information. The object of the present invention is to provide a chat system, etc., which allows the user to easily select a chat room that fits in with his or her tastes.

### FIELD OF THE INVENTION

The present invention relates to a chat system, a chat information processing device, a chat information processing method and a recording medium thereof, which are used for improving the functionality of chats that have been carried out on the Web. Especially the present invention relates to a chat system, a chat information processing device, a chat information processing method and a recording medium for providing reference information to allow chat users to easily select a chat room that fits in with his or her tastes.

### BACKGROUND OF THE INVENTION

In recent years, along with the development of Internet techniques, communication systems, which allow a plurality of people to communicate with each other by utilizing these Internet techniques, have come to be widely used.

Such general communication systems utilizing the Internet include the electronic mail that electronically delivers character data, image data and the like through a server device and the chat that allows users to carry on a dialogue with each other in a virtual chat room.

Of these, the chat is superior in real-time property since interactive sentences inputted through client devices are immediately reflected to a Web page (chat page) constituting a chat room, and is effectively used as a virtual communication space.

At present, these advantages have rapidly increased the number of users of the chat, and there have been an increase in the number of Web sites for providing the chat environment and the number of chat rooms opened in the respective Web sites day after day.

However, in the present circumstances where there are many chat rooms opened, it has become difficult for the user to select a chat room to which he or she joins.

In other words, conventionally, the Web site for providing the chat has a display that indicates room names and themes that show the contents of dialogues that are being carried out in respective chat rooms, or the number of participants at that point of time in the respective chat rooms, and the user refers to these room names and the like, and is allowed to select a chat room to which he or she joins.

However, in the case when many chat rooms are open, it is difficult to check all the room names, etc., resulting in a difficulty in selecting a chat room based upon the room names or the like.

In particular, since the contents of dialogues in the respective chat rooms change in real time, even when the room name or the like matches the interest of the user, the contents of the dialogue at that point of time do not necessarily conform to the interest of the user. Therefore, in order to determine whether or not the chat room is appropriate, the user needs to actually enter each chat room, and needs to repeat wasteful log-ins and log-outs, resulting in wasteful time, etc.

Moreover, even when the user has a chat room to which he or she joined in the past to find it fit in with his or her tastes, he or she does not necessarily remember the URL (Uniform Resource Locator) of the Web page in which the chat room visited in the past is opened or the room name of the chat room. Furthermore, even in the case when he or she remembers the URL or the like, since the chat room itself might be opened or closed by free wills of the respective users, it is unknown whether or not the chat room is open at that point of time. Consequently, it is necessary to actually enter the corresponding chat room, and it is not possible to avoid having wasteful time as described above.

As clearly shown by the above description, in these days when a great number of chat rooms are open, there have been strong demands for a unique selection unit which allows the user to easily select a chat room that fits in with his or her tastes.

### SUMMARY OF THE INVENTION

The present invention has been achieved in order to solve the above problems, and it is an object of the invention to provide a chat system, a chat information processing device, a chat information processing method and a recording medium thereof, which allows the user to easily select a chat room that fits in with his or her tastes.

In order to achieve such an object, a first aspect of the invention provides a chat system comprising, a plurality of information terminal devices respecting associated with plural chat users, and a chat information processing device connected to the information terminal devices through a computerized network for processing information relating to computerized chats, wherein said chat information processing device includes, a comment contents extraction process arrangements for extracting the contents of a comment transmitted from said information terminal devices in each of a plurality of chat rooms, a comment contents data base for storing the contents of a comment extracted by the comment contents extraction process arrangements with relating to each of the chat rooms in which the comment has been made or with relating to each of the users that has made the comment, a reference information generating arrangements for generating reference information based upon the contents of the comment stored in the comment contents data base for use as reference information when said user selects a chat room, and an inform arrangements for informing said information terminal device of the reference information generated by the reference information generating arrangements.

According to this system, the contents of a comment in each chat room are extracted, and stored for each of the chat rooms or for each of the users, reference information that is used as reference when each user makes a selection from chat rooms is generated based upon the contents of the comment, and the reference information is informed to each of the users. Therefore, the user is allowed to select a chat room based upon the contents of comments that have been made in the chat room, and consequently to easily make the selection quickly.

Moreover, the present invention relates to chat information processing device for processing information relating to computerized chats when connected to a plurality of information terminal devices respecting associated with plural chat users through a computerized network, comprising, a comment contents extraction process arrangements for extracting the contents of a comment transmitted from said information terminal devices in each of a plurality of chat rooms, a comment contents data base for storing the contents of a comment extracted by the comment contents extraction process arrangements with relating to each of the chat rooms in which the comment has been made or with relating to each of the users that has made the comment, a reference information generating arrangements for generating reference information based upon the contents of the comment stored in the comment contents data base for use as reference information when said user selects a chat room, and an inform arrangements for informing said information terminal device of the reference information generated by the reference information generating arrangements.

According to this device, the contents of a comment in each chat room are extracted, and stored for each of the chat rooms or for each of the users, and based upon the contents of the comment, reference information that is used as reference when the user makes a selection from chat rooms is generated, and informed to the user. Therefore, the user is allowed to select a chat room based upon the contents of comments that have been made in the chat room, and consequently to easily make the selection quickly.

Moreover, the chat information processing device according to a third aspect of the invention, which relates to a chat information processing device according to the second aspect of the invention, comprising, a comment contents description-limit arrangements for performing a language analysis on the contents of the comment extracted by the comment contents extraction process arrangements so that the contents of comment to be stored in the comment contents data base are limited only to those meaningful contents.

According to this device, the language analysis is carried out on the contents of the comment, and only those contents of comments that are highly meaningful are stored in the comment contents storing unit. Therefore, the reference information can be generated in a manner so as to exclude information that is not used as reference upon determining the contents of a chat room, such as the contents of comments only including sound effects or facial characters, etc. With this arrangement, it is possible to reduce the number of data to be stored or retrieved, to reduce the system load, and consequently to carry out an effective retrieving operation quickly.

Moreover, the chat information processing device according to a fourth aspect of the invention, which relates to the chat information processing device according to the second and third aspects of the invention, comprising, a comment contents time-limit arrangements for limiting the contents of the comment to be stored in the comment contents data base to those contents of the comment that have been made within a predetermined time closest to that point of time.

According to this device, only those contents of a comment that have been made within a predetermined time closest to that point of time are stored in the comment contents storing unit. Therefore, when reference information is generated, it is possible to exclude those pieces of information that are not used as reference in determining the contents of a chat room because a certain period of time has elapsed since the information was given. Therefore, it becomes possible to reduce the number of data to be stored or retrieved, to reduce the system load, and consequently to carry out an effective retrieving operation quickly.

Moreover, there is provided the chat information processing device according to a fifth aspect of the invention, which relates to the chat information processing device according to any one of the second to fourth aspects of the invention, wherein, the reference information generating arrangements comprises, a retrieve process arrangements for performing retrieval on the contents of the comment stored in the comment contents data base based upon a key word transmitted from said information terminal device, and which allows the results of the retrieval to form the reference information.

According to this device, based upon a key word transmitted from each of the users through the information terminal device, retrieval is carried out on the contents of comments stored in the comment contents storing unit. Therefore, the user is allowed to carry out a keyword retrieving operation with respect to the contents of previous comments so that it is possible for the user to easily select a chat room or the like that fits in with his or her tastes quickly.

Moreover, there is provided the chat information processing device according to a sixth aspect of the invention, which relates to the chat information processing device according to any one of the second to fifth aspects of the invention, wherein, the reference information generating arrangements comprises, a second process arrangements for performing retrieval on the contents of the comment stored in the comment contents data base, based upon the contents of other comments stored in the comment contents data base, and allows the results of the retrieval to form the reference information.

According to this device, based upon the contents of past comments made by the user, retrieval is carried out on the contents of comments stored in the comment contents storing unit, and the results of this retrieval are given to the user as reference information. Therefore, the user is allowed to automatically select a chat room or the like that fits in with his or her contents of comments. In particular, in this case, the contents of past comments of each user are automatically accumulated and used as a keyword, therefore, a chat room which fits in with the user's tastes that the user himself or herself has not been aware of might be selected, and the user becomes free from time consuming tasks for inputting a keyword.

Here, there is provided the chat information processing device according to a seventh aspect of the invention, which relates to the chat information processing device according to any one of the second to sixth aspects of the invention, wherein, the reference information generating arrangements comprises, a reference information extraction process arrangements for extracting the contents of the comment stored in the comment contents data base, and allows the results of the extracting to form the reference information.

According to this device, one portion or the entire portion of the contents of a comment stored for each of chat rooms by the comment contents storing unit is extracted, and given to the user as reference information. Therefore, without the necessity of logging in a chat room, the user can view the contents thereof so that he or she is allowed to easily select a chat room or the like that fits in with his or her tastes quickly.

Moreover, a chat information processing device according to an eighth aspect of the invention, comprising, a participation history extraction process arrangements for extracting information used for identifying a chat room to which said user has joined, a participation history data base for storing information extracted by the participation history extraction process arrangements with relating to each of the users who has joined to the chat room, a reference information generating arrangements for generating reference information based upon the information stored in the participation history data base for use as reference information when said user selects a chat room, and an inform arrangements for informing said information terminal device of the reference information generated by the reference information generating arrangements.

According to this device, information used for identifying a chat room to which the user has joined is stored for each of the users, and based upon this information, reference information is generated, and given to the user. Therefore, even when the user does not remember a chat room he or she has joined before, he or she can easily join this chat room.

Here, a chat information processing device according to the ninth aspect of the invention, comprising, a participation number limit arrangements for limiting information to be stored in the participation history data base only to those information that correspond to a predetermined number of participation closest to that point of time.

According to this device, information used for identifying a chat room to which the user has joined is limited to those pieces of information that correspond to a predetermined number of participation closest to that point of time. Therefore, reference information is generated while excluding those pieces of information that are not used as reference for determining the contents of a chat room because a certain period of time has elapsed since the last participation. With this arrangement, it becomes possible to reduce the number of data to be stored or retrieved, to reduce the system load, and consequently to carry out an effective retrieving operation quickly.

Moreover, there is provided the chat information processing device according to a tenth aspect of the invention, which relates to the chat information processing device according to the eighth or ninth aspect of the invention, wherein, the reference information generating arrangements calculates the frequency of participation of each of the users to each chat room, and limits the reference information to be informed to said information terminal device based upon the frequency of participation.

According to this device, information used for specifying a chat room that a user has participated in is limited to those pieces of information of a chat room in which the user has participated not less than a predetermined frequency. Therefore, it is possible to generate reference information by excluding those pieces of information related to chat rooms that the user has participated in only once, or seldom participated in. Thus, it becomes possible to reduce the number of data to be stored or retrieved, to reduce the system load, and consequently to carry out an effective retrieving operation quickly.

Moreover, there is provided the chat information processing device according to an eleventh aspect of the invention, which relates to the chat information processing device according to any one of the eighth to tenth aspects of the invention, wherein, the reference information generating arrangements carries out a predetermined weighting process on the reference information, and limits the reference information based upon the results of the weighting process only to those information that is informed to said user.

According to this device, a predetermined weighting process is carried out on the reference information, and based upon the results of the weighting process, the reference information to be informed to the user is limited. Therefore, among pieces of information used for identifying a chat room in which the user has participated, those pieces of information that are of great importance for the user are preferentially presented, thus, it is possible to enhance the validity of the reference information.

Moreover, there is provided the chat information processing device according to a twelfth aspect of the invention, which relates to the chat information processing device according to any one of the eighth to eleventh aspects of the invention, wherein, the reference information generating arrangements uses only information relating to chats that are open at that point of time as reference information.

According to this device, only information relating to chats that are open at that point of time are given to the user as reference information. Therefore, even in the case when a chat room is dynamically formed or frequently shifted, it is possible to present effective reference information at that point of time.

Furthermore, a chat information processing device according to a thirteenth aspect of the invention, comprising, an opening history extraction process arrangements for extracting information relating to the opening history of a chat room, an opening history data base for storing information extracted by the opening history extraction process arrangements for each of chat rooms, a reference information generating arrangements for generating reference information relating to time at which said chat room is opened, based upon information stored in the opening history data base, and an inform arrangements for informing said information terminal device of the reference information generated by the reference information generating arrangements. According to this device, information related to a chat room opening history that has been opened is stored for each of chat rooms, and based upon this opening history, reference information relating to time at which a chat room is opened is generated, and this is given to the user. Therefore, in addition to information related to the past chat rooms, information relating to chat rooms that have not been opened at that point of time can be given so that the user is allowed to easily determine a plan for participating in the chat room or the like quickly.

Moreover, the present invention also relates to a chat information processing method, and the chat information processing method according to a fourteenth aspect of the invention, comprising, (a) extracting information used for identifying a chat room to which said user has joined, (b) storing information extracted by the extracting step (a) in said chat information processing device with relating to each of the users who has joined to the chat room, (c) generating reference information based upon the information stored at the storing step (b) for use as reference information when said user selects a chat room, and (d) informing said information terminal device of the reference information generated by the generating step (c).

According to this method, the contents of a comment in each chat room are extracted, and stored for each of the chat rooms or for each of the users, and based upon the contents of the comment, reference information that is used as reference when the user makes a selection from chat rooms is generated, and informed to the user. Therefore, the user is allowed to select a chat room based upon the contents of comments that have been made in the chat room, and consequently to easily make the selection quickly.

Furthermore, a chat information processing method according to a fifteenth aspect of the invention, comprising, (a) extracting information used for identifying a chat room to which said user has joined, (b) storing information extracted by the extracting step (a) in said chat information processing device with relating to each of the users who has joined to the chat room, (c) generating reference information based upon the information stored at the storing step (b) for use as reference information when said user selects a chat room, and (d) informing said information terminal device of the reference information generated by the generating step (c).

According to this method, information used for identifying a chat room in which a user has participated before is stored for each of the users, and based upon this information, reference information is generated and given to the user. Therefore, even in the case when the user does not remember chat rooms in which he or she has participated before, he or she is allowed to easily join to such a chat room.

Here, a chat information processing method according to a sixteenth aspect of the invention, comprising, (a) extracting information relating to the opening history of a chat room, (b) storing information extracted by the extracting step (a) in said chat information processing device for each of chat rooms, (c) generating reference information relating to time at which said chat room is opened, based upon information stored in the storing step (b), and (d) informing said information terminal device of the reference information generated by the generating step(c).

According to this method, information relating to the opening history of a chat room that has been opened is stored for each of the chat rooms, and based upon this opening history, reference information relating to time at which the chat room is opened is generated and given to the user. Therefore, in addition to information related to the past chat rooms, information relating to chat rooms that have not been opened at that point of time can be given so that the user is allowed to easily determine a plan for participating in the chat room or the like quickly.

Moreover, the present invention relates to the recording medium, and there is provided the recording medium according to a seventeenth aspect of the invention, wherein a computer program thereon, the computer program for a computer to execute any one of chat information processing methods according to the present invention.

According to this recording medium, by allowing a computer to read and execute the program recorded on the recording medium, the chat information processing method according to any one of the fourteenth to sixteenth aspects of the invention is achieved by utilizing the computer so that the same effects as those obtained through each of these methods are exerted.

Here, “computer-readable recording media” include any “portable physical medium”, such as floppy disks, magneto-optical disks, ROMs, EPROMs, EEPROMs, CD-ROMs and DVDs, or any “fixed-type physical medium”, such as ROMs, RAMs and HDs, that is installed in various types of computer systems, or any “communication medium” for temporarily holding a program, such as a communication line and a carrier wave, that is used in the case when a program is transmitted through a network typically represented by LAN, WAN and the Internet.

Moreover, “programs” refer to a data processing method described in any desired language and description method, and any format, such as source codes and binary codes, may be used. Here, not limited to those singly constituted, “programs” may include those constituted in a dispersed manner as a plurality of modules and libraries, and those that exert their functions in cooperation with another program typically represented by an OS (Operation System). In the respective devices shown in preferred embodiments, with respect to specific constructions for reading the recording medium, the reading sequence or the installing sequence after the reading operation, the presently known constructions and sequences may be used.

Other objects and features of this invention will become understood from the following description with reference to the accompanying drawings.

### BRIEF DESCRIPTION OF THE DRAWINGS

FIG. 1 is a block diagram that shows the entire construction of the present system according to a first embodiment of the present invention;

FIG. 2 is a drawing that shows a structural example of information stored in a member DB;

FIG. 3 is a drawing that shows a structural example of information stored in a chat room DB;

FIG. 4 is a drawing that shows a structural example of information stored in a comment content DB;

FIG. 5 is a flow chart that shows a comment content storing process;

FIG. 6 is a flow chart that shows a comment content updating process;

FIG. 7 is a flow chart that shows a retrieving process;

FIG. 8 is a drawing that shows a display example of an initial screen of chats;

FIG. 9 is a drawing that shows a display example of a display screen bearing the results of retrieval;

FIG. 10 is a block diagram that shows the entire construction of the present system according to a second embodiment of the present invention;

FIG. 11 is a flow chart that shows a personal comment contents storing process;

FIG. 12 is a drawing that shows a flow chart of a retrieving process;

FIG. 13 is a drawing that shows a display example of an initial screen of chats;

FIG. 14 is a block diagram that shows the entire construction of the present system according to a third embodiment of the present invention;

FIG. 15 is a flow chart that shows a reference information presenting process;

FIG. 16 is a drawing that shows a display example of a comment contents display screen;

FIG. 17 is a block diagram that shows the entire construction of the present system according to a fourth embodiment of the present invention;

FIG. 18 is a flow chart that shows a participation history storing process;

FIG. 19 is a flow chart that shows a reference information presenting process;

FIG. 20 is a block diagram that shows the entire construction of the present system according to a fifth embodiment of the present invention;

FIG. 21 is a flow chart that shows an opening history storing process;

FIG. 22 is a flow chart that shows a reference information presenting process;

FIG. 23 is a drawing that shows a display example of an initial screen of chats.

### DETAILED DESCRIPTIONS

Referring to Figures, the following description will discuss a chat system (hereinafter, referred to as the present system), a chat information processing device, a chat information processing method and a recording medium according to the first to fifth embodiments of the present invention in detail. However, the present invention is not intended to be limited by the first to fifth embodiments.

(First Embodiment)

(Outline of Entire System)

First, an explanation will be given of a first embodiment.

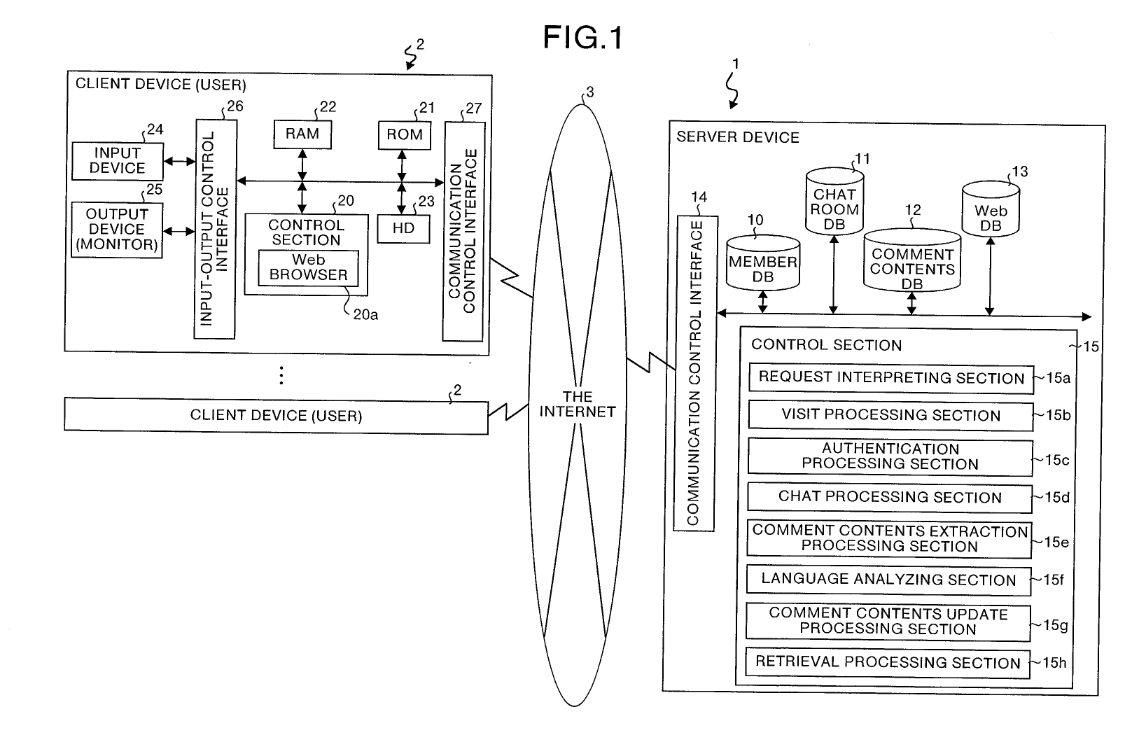

FIG. 1 is a block diagram that shows the entire construction of the present system. As shown in FIG. 1, the present system is constituted by a server device 1 that is a chat information processing device and a plurality of client devices 2 that are information terminal devices, which are connected to each other through the Internet 3 so as to communicate with each other. The following description will discuss the outline of the present system, and the construction of the present system and operations thereof will be then described in detail.

In the present system, the server device 1 stores data (Web data) of a plurality of Web pages constituting a plurality of chat rooms and various Web data, such as using guidance for the chat rooms. Here, a user, who is registered as a member of the present system, makes an access to the server device 1 through the client device 2, and is allowed to view the using guidance of the chat rooms and participate in the chat by downloading Web data.

In this case, the user selects one or some chat rooms among a plurality of chat rooms, and can participate therein, and at this time, reference information that is used upon selecting the chat room is given to the user.

The reference information in this embodiment is schematically given as the result of retrieval that is obtained by the user by carrying out a keyword retrieval on the contents of comments in a chat room. With this arrangement, the user is allowed to select a chat room that fits in with his or her tastes, based upon the contents of comments that are actually going on in the chat room.

In particular, the contents of comments to be retrieved at this time are those contents of comments that are selected based upon a predetermined reference. With respect to the references of selection, there are a reference on the contents of comments and a reference on time.

With respect to the reference on the contents of comments, a method in which a language analysis is carried out on the contents of comments so that only the meaningful contents of comments are extracted so as to be retrieved is listed. Thus, it is possible to exclude information that is not used as reference upon determining the contents of comments in a chat room, such as the contents of comments only including sound effects or facial characters, etc., and consequently to improve the effectiveness of the retrieving operation.

Moreover, with respect to the reference on time, using the time at which the user carries out the retrieving operation as a reference, only the contents of comments that are made within a predetermined time closest to the reference time may be used as the contents to be retrieved. Thus, the contents of comments that were made a long time ago and might be far apart from the contents of the present comments may be excluded from the contents to be retrieved, thus, it becomes possible to improve the effectiveness of the retrieving operation.

(System Construction—Server Device 1)

Next, an explanation will be given of the system construction for achieving such a chat environment.

First, an explanation will be given of the construction of the server device 1. In FIG. 1, the server device 1 is schematically constituted by a member DB (DB=data base) 10, chat rooms DB11, a contents of comments DB12, a Web DB13, a communication control IF (IF=interface) 14 and a control section 15, and these parts are connected to each other through respective communication paths so as to allow communications with each other. Moreover, the server device 1 is connected to the Internet 3 through a communication device such as a router and a dedicated line, not shown, so as to allow communications with each other. Here, an access to each DB is actually carried out through DBMS (Database Management System), however, the description of this DBMS is omitted.

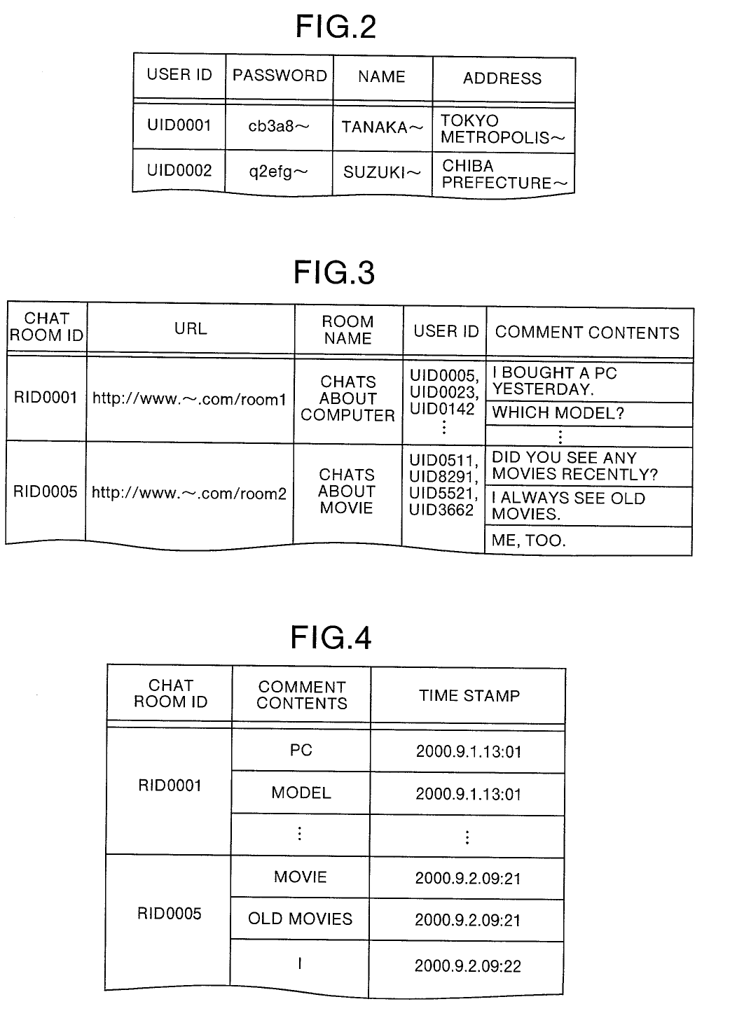

Among these constituent components of the server device 1, the member DB10 is a user information storing unit which stores information related to users who have been registered as members of the present system. For example, as shown in FIG. 2, specific information, stored in the member DB10, includes, a user ID used for uniformly identifying each of the users, a password used for authenticating each of the users, the name of each user and the address of each user, all of which are stored in association with each other. Here, with respect to information related to the users, in addition to the above-mentioned information, desired information for identifying the attributes of each of the users can be stored, for example, the age, sex, occupation, hometown, tastes, etc. of each user can be stored therein.

Here, the chat room DB11 is a chat room information storing unit which stores information relating to chat rooms that are open at that point of time. For example, as shown in FIG. 3, specific information to be stored in the chat room DB11 include a chat room ID used for uniformly identifying each of the chat rooms, a URL of a Web page constituting each of the chat rooms, a room name of each chat room, user IDs of the users participating in each of the chat rooms and contents of comments of each of the users (for example, text data), all of which are stored in association with each other.

Moreover, the contents of comments DB12 is a comment contents data base which stores the contents of comments given in each of the chat rooms that are open at that point of time for each of the corresponding chat rooms. For example, as shown in FIG. 4, specific information to be stored in the contents of comments DB12 includes a chat room ID of each of the chat rooms, the contents of comments given in each of the chat rooms and a time stamp indicating the time at which the contents of each comment are stored, all of which are stored in association with each other.

Here, the contents of comments to be stored in the contents of comments DB12 are those contents of comments that are selected from the contents of comments stored in the chat room DB11, in conformity with the above-mentioned time reference and the reference based upon the contents of comments.

Moreover, the Web DB13 stores various Web data to be transmitted to each client device 2. These Web data include data used for displaying a member private screen, which will be described later, and the initial screen for chats, and the like, and these data are formed as text files described in, for example, HTML and XML. In addition to these, the Web DB 13 can store, if necessary, sound data to be transmitted to each client device 2 as sound files having a format such as WAVE format and AIFF format and still images and motion picture images as image files having a format such as JPEG format and MPEG2 format.

Here, in FIG. 1, the communication control IF 14 carries out communication control between the server device 1 and the Internet 3 (or s communication device such as a router), and serves as an inform arrangements which informs the client device 2 of reference information (the results of retrieval) generated in a retrieval processing section 15h.

Moreover, in FIG. 1, from the view point of conceptual functions, the control section 15 is constituted by a request interpreting section 15a, a visit processing section 15b, an authentication processing section 15c, a chat processing section 15d, a comment contents extraction processing section 15e, a language analyzing section 15f, a comment contents update processing section 15g and a retrieval processing section 15h.

Among these, the request interpreting section 15a serves as a request interpreting unit which interprets the contents of a request from the client device 2 and which transmits and receives the corresponding processes to and from the other parts of the control section 15 according to the results of interpretation. Moreover, the visit processing section 15b serves as a visit processing unit which, upon receipt of a request for visiting various screens from each of the client devices 2, generates and transmits Web data for these screens. Moreover, the authentication processing section 15c serves as an authentication processing unit which, upon receipt of a request for authentication from each of the client devices 2, carries out a determination on authentication.

Moreover, the chat processing section 15d serves as a chat processing unit which carries out processes relating to a chat management such as generation of Web data for chat pages and management on the users who are participating in chats. Furthermore, the comment contents extraction processing section 15e serves as a comment contents extraction prosecc arrangements which extracts the contents of comments in each of the chat rooms, and stores them in the comment contents DB12. The language analyzing section 15f serves as a comment contents description-limit arrangements, which for performe a language analysis on the contents of comments extracted by the comment contents extraction processing section 15e with respect to the contents of comments to be stored in the comment contents DB12 so that a limitation is made only to meaningful contents of comments. Moreover, the comment contents update processing section 15g serves as a comment contents time-limit arrangements which limits the contents of comments to be stored in the comment contents DB12 to only those contents of comments given within a predetermined time closest to that point of time.

Here, the retrieval processing section 15h is a reference information generating arrangements which generates reference information used as reference by the user upon selecting a chat room based upon the contents of comments stored in the comment contents DB12, and in the present embodiment, this serves as a retrieve process arrangements which, based upon a keyword transmitted through the client device 2 from each of the users, retrieves the contents of comments stored in the comment contents DB12 and allows the results of this retrieval to form the above-mentioned reference information.

Here, with respect to processes to be carried out in these parts, a detailed explanation will be given of them later.

The above explanation has been given of the construction of the server device 1, however, the respective constituent components in the Figures are drawn from the viewpoint of conceptual functions, and the device is not necessarily designed physically as shown in the drawing.

For example, with respect to processing functions that each server of the server device 1 is provided with, that is, in particular, respective processing functions carried out by the control section 15, the entire portion or desired portions thereof can be achieved by a CPU (Central Processing Unit) and a program that is interpreted or executed by the CPU, or can be achieved by hardware made of wired logics. Here, the program is stored in the present recording medium, not shown, and is mechanically read by the server device 1 on demands.

Moreover, specific dispersed and integrated states of the server device 1 are not intended to be limited by those shown in the Figures, and the entire portion or desire portions thereof can be composed in a functionally or physically dispersed or integrated manner in a desired unit determined based upon various loads, etc. For example, the Web DB13 may be formed independently as a Web server device 1, or the chat room DB11 and the comment contents DB12 may be integrally formed as a signal DB. Here, with respect to structural functions of the actual server device 1, functions of a fire-wall server and a DNS (Domain Name System) server may be added thereto, and in this case, since known constructions can be applied, the description thereof is omitted.

(System Construction—User Client Device 2)

Next, an explanation will be given of the construction of the client device 2 of each of the users. As shown in FIG. 1, the client device 2 is schematically constituted by a control section 20, a ROM 21, a RAM 22, a HD 23, an input device 24, an output device 25, an input-output control IF 26 and a communication control IF 27, and these components are connected through buses so as to communicate with each other.

This client device 2 is achieved by, for example, a device, such as a personal computer and a work station, a home-use game machine, an Internet TV and a PDA (Personal Digital Assistant), or a mobile communication terminal, such as a mobile telephone and a PHS (Personal Handy Phone System).

The control section 20 of this client device 2 is provided with a Web browser 20a. This Web browser 20a basically interprets Web data, and carries out a display controlling process (browsing process) for allowing a monitor 25, which will be described later, to display the resulting data.

The entire portion or desired portions of the control section 20 can be achieved by a CPU and a program that is interpreted and carried out by the CPU. In other words, a computer program, which gives instructions to the CPU in cooperation with an OS (Operating System) so as to carry out various processes, is stored in the ROM 21 or the HD 23. This computer program, which is executed by being loaded by the RAM 22, constitutes the control section 20 in cooperation with the CPU.

However, this computer program may be stored in an application program server that is connected to the client device 2 through a desired internet system 3, or, if necessary, the entire portion or one portion thereof may be downloaded. The entire portion or desired portions of the control section 20 may be realized as hard ware made of wired logics, etc.

Moreover, with respect to the input device 24, a tool such as a keyboard, a mouse and a microphone, may be used. Moreover, a monitor 25, which will be described later, achieves pointing device functions in cooperation with the mouse.

Furthermore, with respect to the output device 25, in addition to a monitor (including a home-use TV), a speaker may be used (here, in the following description, the output device 25 is referred to as a monitor 25).

The client device 2, designed as described above, is connected to the Internet 3 through a communication device, such as a modem, a TA and a router, and a telephone line or through a private line, and is allowed to make an access to the server device 1 in conformity with a predetermined communication protocol (for example, TCP/IP Internet Protocol).

(Network)

Here, with respect to the network to be connected to the server device 1 and client device 2, not limited to the above-mentioned Internet 3, any desired network may be used. For example, the present system may be formed by using LAN, WAN or a personal computer communication network within a limited area. Moreover, in addition to these, by using ground waves, CATV, CS, BS or ISDB (Integrated Services Digital Broadcasting), various data may be transmitted and received. In other words, not limited to cable networks, the network may include these radio-communication networks.

(Processes in the Present System)

Next, a detailed explanation will be given of processes that are executed by using the present system arranged as described above. These processes are mainly classified into a basic process used upon making conversations in chats, a comment contents storing process for storing the contents of comments in chats for each of the chat rooms, a comment contents updating process for updating the stored comment contents and a retrieving process in which the user makes a retrieval upon participating in a chat.

(Basic Processes Used Upon Carrying out Conversations in Chats)

First, an explanation will be given of the basic processes used upon carrying out conversations in chats. However, since these processes can be carried out in the same manner as those of the known chat system, the explanation will be briefly given of the outline thereof. Moreover, it is the premise that the respective users have been registered as members of the present system through proper methods, and that the user ID, password, name and address of them have been stored in the member DB10.

First, the user inputs a predetermined URL corresponding to the initial screen of the present system in the input frame of the Web browser 20a of the client device 2. Then, when he or she instructs the screen update, the Web browser 20a transmits this URL through the communication control IF 27 in conformity with a predetermined communication protocol, and makes a request for transmission of the initial screen to the server device 1 through routing based upon this URL.

Here, the request interpreting section 15a of the server device 1 monitors the presence or absence of transmission from the client device 2, and upon receipt of transmission, analyzes the contents thereof, and transfers necessary processes to the corresponding parts inside the control section 15, based upon the results of the analysis. In the case when the contents of the transmission relate to a request for transmission of the initial screen, it acquires Web data for displaying the initial screen from the Web DB13 under control of the visit processing section 15b, and transmits the Web data to the client device 2 through the communication control IF 14.

The client device 2 receives the Web data from the server device 1 through the communication control IF 27, and interprets the data by using the Web browser 20a to display the initial screen on the monitor 25 (supposing that the screen request to the server device 1 from the client device 2, the transmission of Web data from the server device 1 to the client device 2 and the display of the Web page in the client device 2 are carried out virtually in the same manner, and the detailed description thereof will be omitted in the following description).

Since the initial screen is desirably composed, the drawing thereof is omitted, however, link buttons used for selecting various menus are placed on this screen, and when the user selects one of the link buttons through the input device 24, an identifier (environment variable) for identifying the contents of the request is transmitted to the server device 1. Then, the request interpreting section 15a of the server device 11 analyzes this identifier so that the contents of the request from the client device 2 are identified (supposing that the identification of the contents of a request from the client device 2 to the server device 1 is carried out in the same manner in the following processes, the detailed description thereof will be omitted in the following description).

In the case when the contents of a request are identified as a log-on request, the visit processing section 15b calls for Web data of the authentication screen from the Web DB13, and transmits the Web data to the client device 2. Consequently, the authentication screen is displayed on the monitor 25.

This screen is used for allowing the user to input information for authentication, and when the user inputs his or her user ID and password in this screen, these pieces of information are transferred to the authentication processing section 15c from the request interpreting section 15a. The authentication processing section 15c compares these pieces of information with the user ID and password stored in the member DB10 so as to carry out authentication on the user. In the case when the user is certified on the authentication, this fact is passed to the visit processing section 15b. Then, the visit processing section 15b calls for Web data of a member private screen from the Web DB13, and transmits this to the client device 2, consequently, the member private screen is displayed on the monitor 25.

Since the member private screen is desirably composed, the drawing thereof is omitted, however, service menus, which are used by the users who are the members, are displayed on this screen, and when the user selects a chat menu, the chat service is started. More specifically, the visit processing section 15b calls for Web data of a chat initial screen from the Web DB13 and transmits the resulting data to the client device 2.

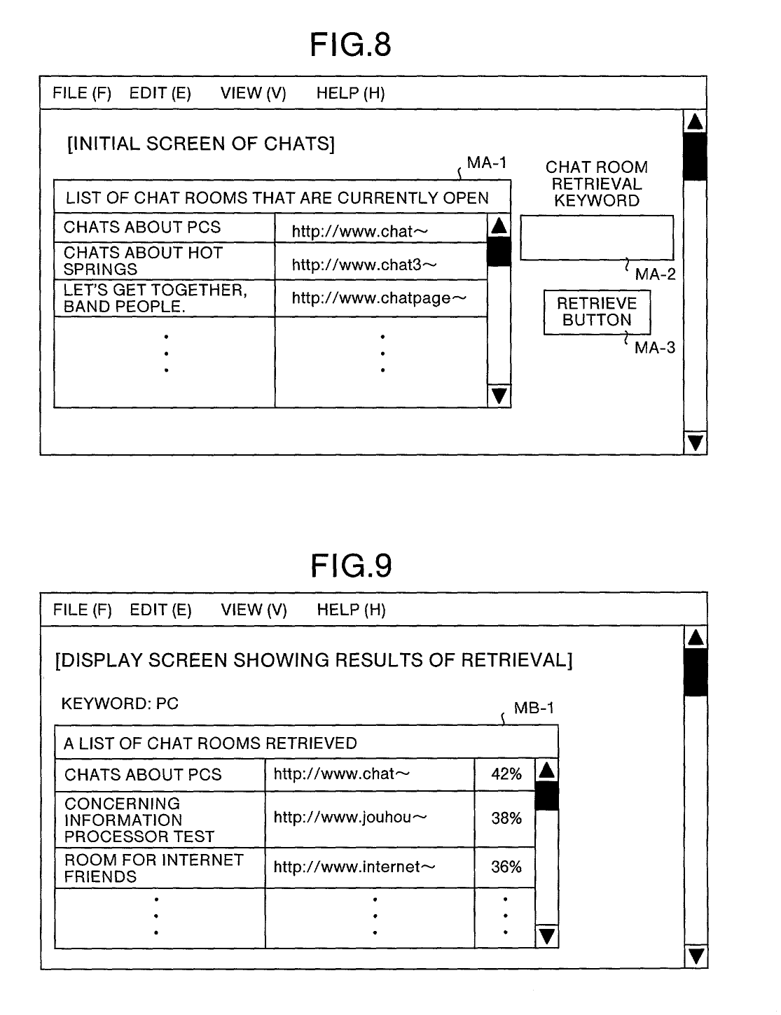

This chat initial screen is a screen for allowing the user to select a desired chat room to participate in, and as shown in FIG. 8, this is constituted by a list MA-1 for chat rooms that are open at that point of time, an input frame MA-2 through which a keyword for carrying out retrieval on chat rooms is inputted and a retrieval button MA-3 for instructing the execution of the retrieval. Here, the list MA-1 for chat rooms is displayed based upon the chat room name and the URL obtained from the chat room DB11. Here, with respect to the input frame MA-2 and the retrieval button MA-3, an explanation thereof will be given in the retrieving process, which will be described later.

When the user selects a desired chat room from the list MA-1 of chat rooms, the Web data of the chat page of the corresponding chat room is transmitted from the server device 1 to the client device 2 so that the chat page is displayed on the monitor 25. Since the chat page is desirably composed, the drawing thereof is omitted, however, this chat page includes an input frame through which the contents of a comment are inputted and a transmission button for instructing the transmission, and when the user inputs the contents of a comment in the input frame through the input device 24, and selects the transmission button, the data of the contents of the comment is transmitted to the server device 1.

Here, in the server device 1, the chat room ID, URL and the room name of each of the chat rooms that are open at that point of time are stored in the chat room DB11. When a chat room is selected in the client device 2, the chat processing section 15d stores the user ID of the user in the chat room DB11 in association with the chat room ID. Moreover, upon receipt of the data of the contents of a comment from the client device 2, the chat processing section 15d updates the contents of comments in the chat room DB11 by using the data.

The updating process of the chat page being displayed on each of the client device 2 is automatically carried out, for example, by re-reading the page with fixed intervals by utilizing a Refresh function of META tags described in the HTML constituting the chat page. Thereafter, in this manner, the contents of comments are reflected to the chat page virtually in real time, allowing the user to carry out virtual communications. Thereafter, until the participation in the chat room has finished, the same processes are carried out.

(Comment Contents Storing Process)

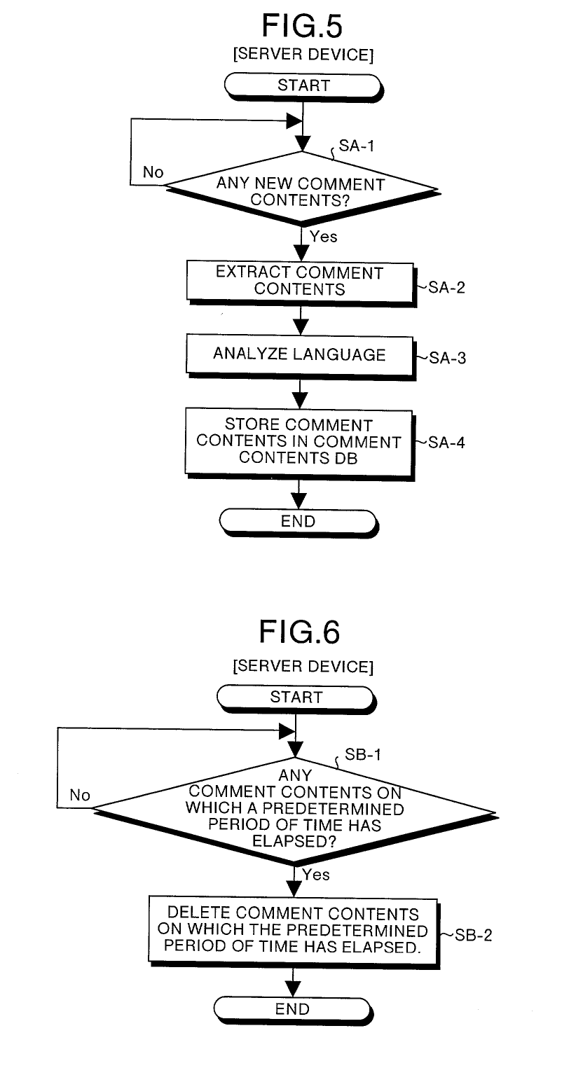

Next, an explanation will be given of the comment contents storing process. This process is automatically executed while the above-mentioned chat basic processes are carried out. FIG. 5 shows a flow chart of this process. As shown in FIG. 5, in this process, the comment contents extraction processing section 15e in the server device 1 monitors the presence or absence of the comment contents transmitted from the client device 2 (step SA-1). In the case when there are new comment contents, the comment contents extraction processing section 15e extracts these comment contents, and passes the resulting comment contents to the language analyzing section 15f (step SA-2).

Upon receipt of the comment contents, the language analyzing section 15f carries out a language analysis on the comment contents, and extracts only those meaningful comment contents contained therein (step SA-3). Here, those meaningful comment contents refer to comment contents having highly effective in specifying the contents of chats in the chat room in which the corresponding comment has been given, and for example, the analyzing process is carried out by extracting all the nouns contained in the comment contents. Such a language analysis can be carried out by a conventionally known language analyzing system, and for example, the comment contents are divided into respective phrases, and these are determined as to whether they are nouns or not based upon their inflected forms or the like so that only the nouns are extracted. More specifically, as shown in FIGS. 3 and 4, from the contents of a comment “Recently, I have brought a PC.”, only “PC” is extracted, and from the contents of a comment “Did you see a movie recently?”, “movie” is extracted.

The contents of comments, thus extracted, are stored in the comment contents DB12 in association with the chat room ID of a chat room in which the corresponding comment has been given, together with a time stamp at that point of time obtained by a known method (step SA-4). Thus, the comment contents storing process is completed.

(Comment Contents Updating Process)

Next, an explanation will be given of the comment contents updating process. FIG. 6 shows a flow chart of this process. As shown in FIG. 6, in this process, the comment contents update processing section 15g of the server device 1 monitors whether or not there are any comment contents on which not less than a predetermined period of time (for example, 10 minutes) has elapsed since the comment contents were stored, with predetermined intervals, among the comment contents stored in the comment contents DB12 (step SB-1). More specifically, for example, the time stamp is called for from the comment contents DB12, while reference is made to the current time at that point of time by using a predetermined unit, and both of the times are compared so as to carry out the above-mentioned monitoring process. If there are any comment contents on which not less than the predetermined time has elapsed, the comment contents and the time stamp are deleted from the comment contents DB12 (step SB-2). Thus, the comment contents updating process is completed.

According to this process, only the comment contents made within a predetermined time closest to the present time are stored in the comment contents DB12, therefore, it is possible to enhance the effectiveness of a retrieving process, which will be described later.

(Retrieving Process)

Next, an explanation will be given of a retrieving process. This process is started when the user manually requests for a chat retrieval, or is automatically started with predetermined intervals. In the present embodiment, when the user inputs a keyword in the input frame MA-2 of the chat initial screen shown in the above-mentioned FIG. 8 and selects the retrieving button MA-3, the retrieving process is started.

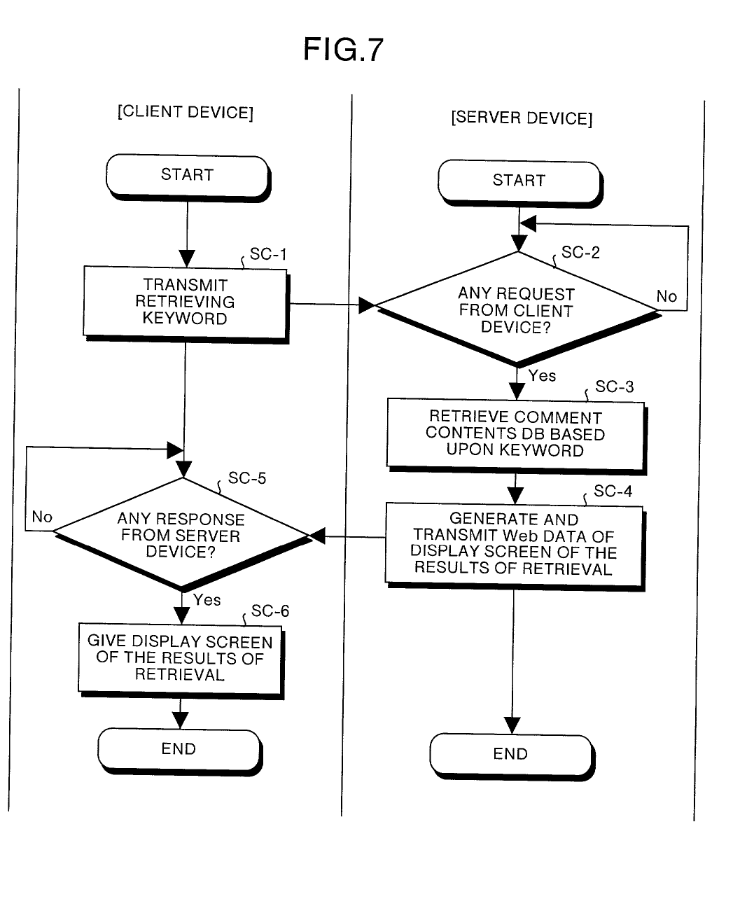

FIG. 7 shows a flow chart of this process. As shown in FIG. 7, the inputted keyword for retrieval is transmitted to the server device 1 (step SC-1, SC-2). Upon receipt of this, the request interpreting section 15a of the server device 1 passes this keyword to the retrieval processing section 15h. Then, based upon this keyword, the retrieval processing section 15hcarries out a retrieving process on the comment contents stored in the comment contents DB12 (step SC-3).

This retrieving process can be carried out by using a known retrieving algorithm. For example, among the comment contents stored in the comment contents DB12, a synonym retrieving process is successively carried out starting from those having the newer time stamp.

Here, with respect to the comment contents to be retrieved, they are limited to those highly meaningful comment contents that have been language-analyzed in the above-mentioned comment contents storing process, and they are also limited to only the recent comment contents by the above-mentioned comment contents updating process, therefore, they are few in the number of data, thereby making it possible to reduce the system load, and to carry out an effective retrieving process quickly.

Then, if there is any matched word as a synonym, the retrieval processing section 15h refers to the chat room DB11 based upon the corresponding chat room ID, and acquires the URL of this chat room. Moreover, the retrieval processing section 15h also acquires the matching rate of the keyword and the contents of comments. Here, the retrieval processing section 15h passes the results of this retrieval to the visit processing section 15b, and the visit processing section 15b generates Web data of a retrieval result display screen for displaying the results of this retrieval, and transmits this to the client device 2 (step SC-4). Consequently, the retrieval result display screen is displayed on the monitor 25 (step SC-5, SC-6) Thus, the retrieving process is completed.

This screen includes information for specifying a chat room that contains the comment contents including the above-mentioned keyword, and information for indicating the accuracy of the information, for example, as shown in FIG. 9, the chat room names and URLs of the respective chat rooms having the comment contents including the keyword and the matching rates of the keyword and the comment contents are displayed as a list MB-1. For example, in the case when the user inputs a key word “PC”, the chat room names and URLs of chat rooms having the comment contents including the word “PC” and the respective matching rates are displayed. Thus, referring to these matching rates, the user selects a desired chat room, and is allowed to view the chat page of this chat room, thus, he or she can participate in the chat.

(Second Embodiment)

(Outline of the Entire System)

Next, an explanation will be given of a second embodiment. This embodiment basically makes it possible to carry out retrieval on a chat room as explained in the above-mentioned first embodiment, and further provides an arrangement in which, by using not a keyword for retrieval inputted by the user, but a keyword that is automatically specified so as to fit in with the user' s tastes based upon the comment contents that the user have made in chat rooms in the past, the retrieval is carried out based upon this keyword.

However, with respect to constructions and processes not specifically explained, supposing that they are the same as those of the first embodiment, the description thereof is omitted. Moreover, the same constituent elements are indicated by the same names and reference numerals.

(System Construction—Server Device)

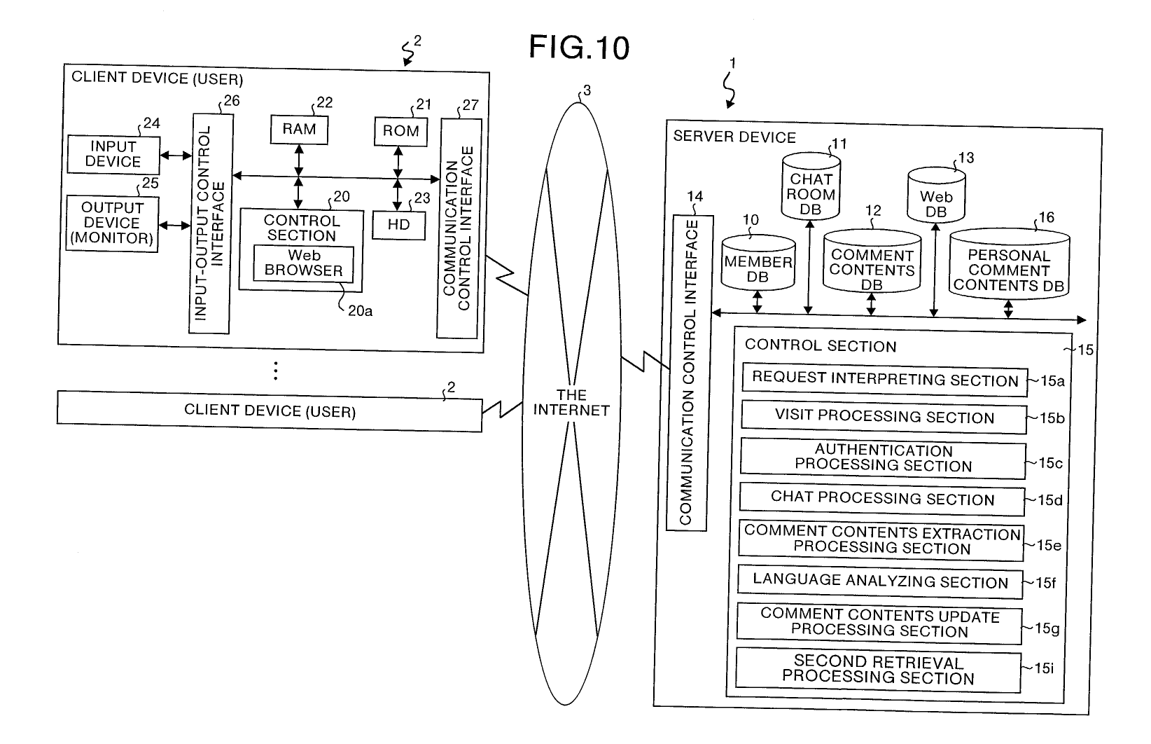

Next, an explanation will be given of the system construction for achieving such a chat environment. First, an explanation will be given of the construction of the server device 1. In addition to the constituent elements of the server device 1 of the first embodiment, the server device 1 of FIG. 10 is further provided with a personal comment contents DB16, and also provided with a second retrieval processing section 15iin place of the retrieval processing section 15h.

Among these, the personal comment contents DB16 is a comment contents storing unit which stores the comment contents in each of the chat rooms for each of the users. Specific pieces of information to be stored in the personal comment contents DB16 include user IDs of the respective users, the comment contents of each of the users and time stamps indicating the time at which the contents of each comment are stored, which are all made in association with each other.

Moreover, the second retrieval processing section 15iserves as a reference information generating unit which generates reference information used as reference by the user upon selecting a chat room, based upon the comment contents stored in the comment contents DB12, and in the present embodiment, it also serves as a second process arrangements which carries out retrieval on the comment contents stored in the comment contents DB12 for each chat room, based upon the comment contents stored in the personal comment contents DB16 for each of the users, and allows the result of this retrieval to form reference information.

(Processes of the Present System)

Next, a detailed explanation will be given of processes that are executed by using the present system having the above-mentioned arrangement. In addition to the basic processes, in the first embodiment, the comment contents storing process and the comment contents updating process of the first embodiment, these processes are mainly provided with a personal comment contents storing process for storing the comment contents of each of the users and a retrieving process for carrying out a retrieving process that is used when the user participates in a chat.

(Personal Comment Contents storing Process)

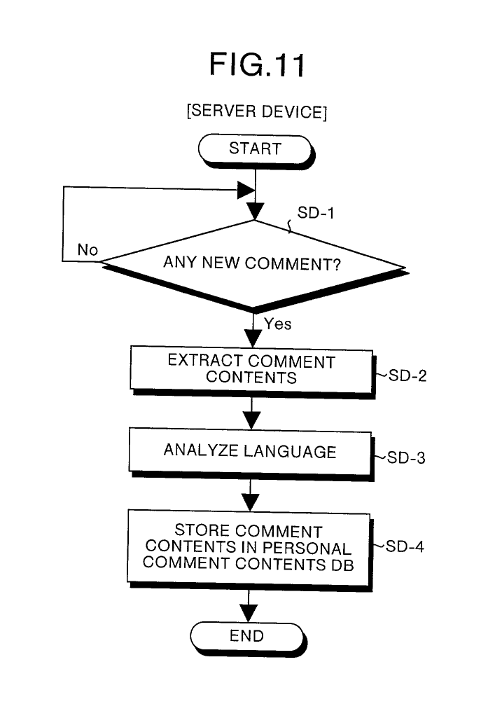

First, an explanation will be given of the personal comment contents storing process. This process is automatically carried out while the aforementioned chat basic processes are being carried out. FIG. 11 shows a flow chart of this process. As shown in FIG. 11, this process is carried out virtually in the same manner as the aforementioned comment contents storing process. In other words, the comment contents extraction processing section 15e of the server device 1 monitors the presence or absence of any comment contents transmitted from the client device 2 (step SD-1). Then, if there are any new comment contents, the comment contents extraction processing section 15e extracts these comment contents, and pass them to the language analyzing section 15f (step SD-2).

Upon receipt of these, the language analyzing section 15f carries out a language analysis on the comment contents, and extracts only those highly meaningful comment contents contained therein (step SD-3). For example, from the comment contents, “I would like to take a rest in a hot-spring resort.”, “hot-spring” is extracted.

The comment contents thus extracted are stored in the personal comment contents DB16 in association with the user ID of the corresponding user who has made the above-mentioned comments, together with a time stamp obtained in a conventionally known method (step SD-4). Thus, the personal comment contents storing process is completed.

(Retrieving Process)

Next, an explanation will be given of a retrieving process. This process is carried out by an instruction from the user executed through a predetermined method, or carried out automatically in a predetermined synchronized timing. In the present embodiment, upon generating Web data of the initial screen of chats in FIG. 8 that has been explained in the basic processes of chats in the first embodiment, the retrieving process is automatically carried out, and the results of this retrieval are reflected to the initial screen of chats.

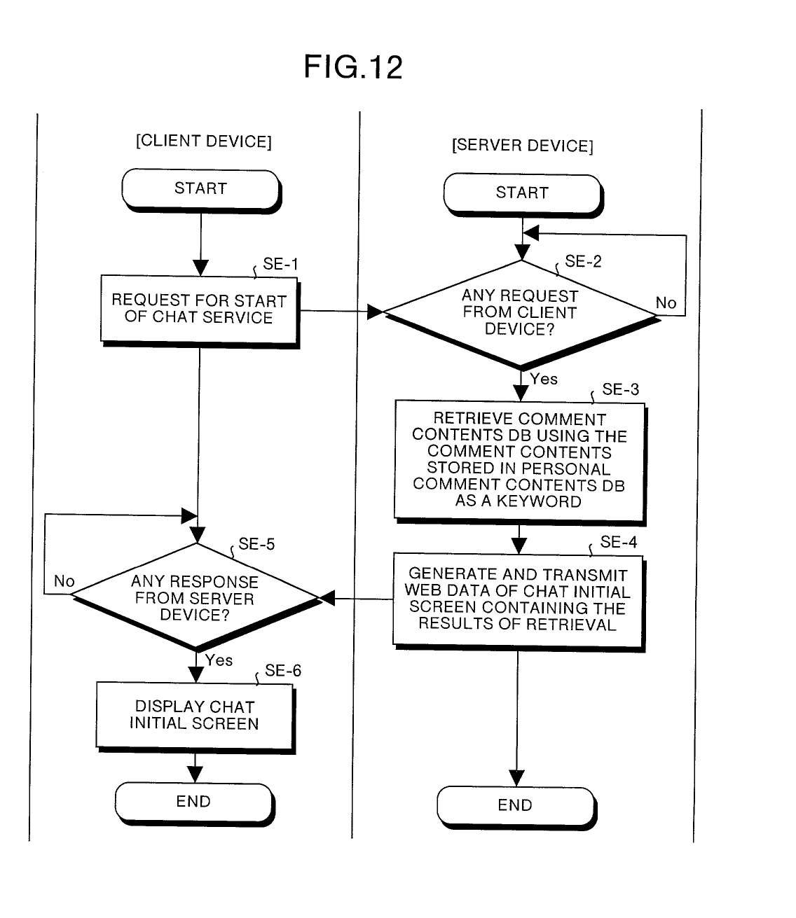

More specifically, when the user selects a chat service from the member private screen, the retrieving process is started. FIG. 12 shows a flow chart of this process. As shown in FIG. 12, when the user makes a request for the start of the chat service, this request is transmitted to the server device 1 (step SE-1). Upon receipt of this, the request interpreting section 15a of the server device 1 passes this to a second retrieval processing section 15i. Then, the second retrieval processing section 15i calls for the comment contents of the corresponding user stored in the personal comment contents DB16, and based upon these comment contents, carries out retrieval on the comment contents stored in the comment contents DB12 (steps SE-2, SE-3).

Then, if there are any matched comment contents, the second retrieval processing section 15i refers to the chat room DB11 based upon the chat room ID, and acquires the URL of this chat room. Moreover, the second retrieval processing section 15i also acquires the matching rate of the comment contents of the user and the contents of comments in the respective chat rooms. Then, the second retrieval processing section 15i passes the results of this retrieval to the visit processing section 15b, and the visit processing section 15b generates Web data of the initial screen of chats containing the results of this retrieval, and transmits this to the client device 2 (step SE-4). Consequently, the initial screen of chats is displayed on the monitor 25 (step SE-5, SE-6). Thus, the retrieving process is completed.

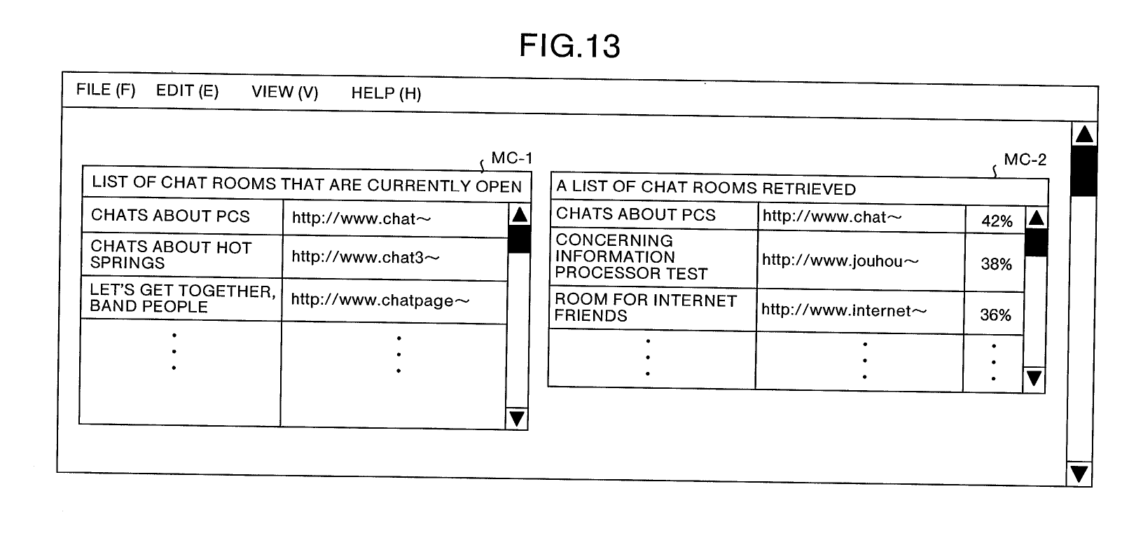

For example, FIG. 13 shows this screen. In the same manner as the initial screen of chats shown in FIG. 8, this screen includes a list of chat rooms that are currently open MC-1, and the chat room names, the URLs and the matching rates of the respective chat rooms obtained by the above-mentioned retrieving process are also displayed as a list MC-2. For example, if the user has made comments concerning “PC”, those chat rooms the comment contents of which include “PC” are displayed. Referring to these matching rates, the user selects a desired chat room, and inputs the URL in a predetermined input frame of the Web browser 20a, and transmits this, thus, he or she can visit the chat page of this chat room, and participate in this chat room.

(Third Embodiment)

(Outline of the Entire System)

Next, an explanation will be given of a third embodiment. In the same manner as the aforementioned first and second embodiments, this embodiment basically makes it possible to record the comment contents of a chat room in the past, however, these comment contents are used not for retrieval, but for display to the user so as to allow him or her to easily confirm the contents of each of the chat rooms quickly.

However, with respect to constructions and processes not specifically explained, supposing that they are the same as those of the first embodiment, the description thereof is omitted. Moreover, the same constituent elements are indicated by the same names and reference numerals.

(System Construction—Server Device 1)

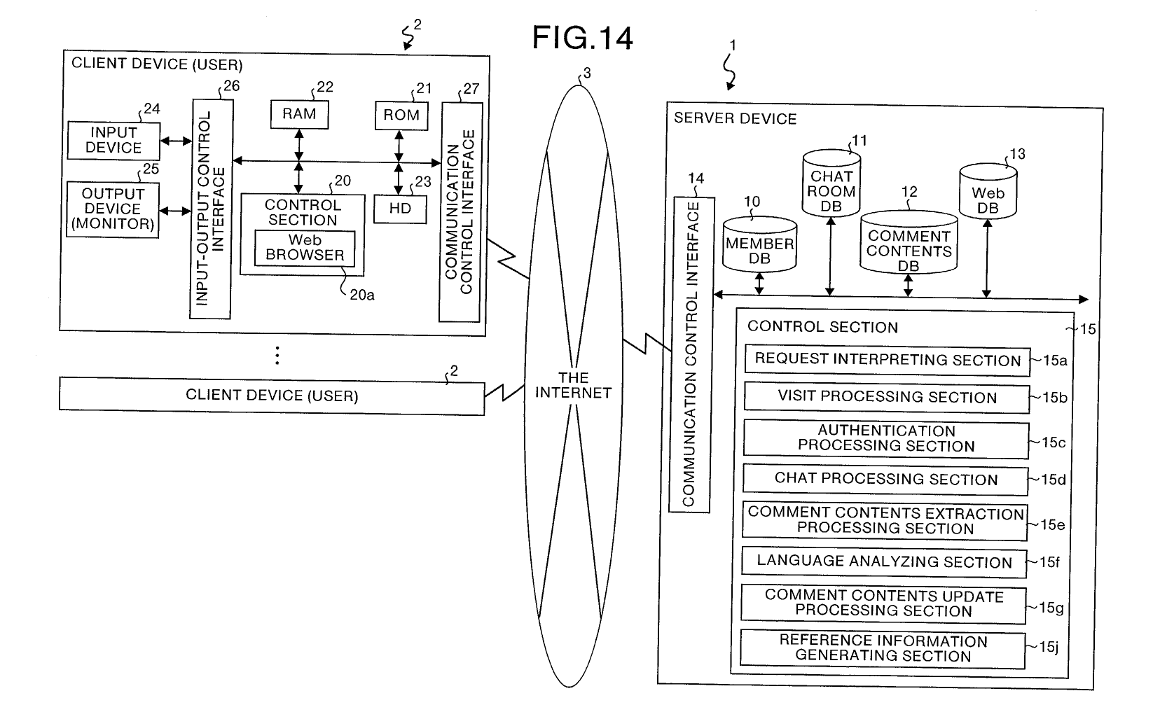

Next, an explanation will be given of the system construction for achieving such a chat environment. First, an explanation will be given of the construction of the server device 1. In FIG. 14, the server device 1 is provided with a reference information generating unit 15j in place of the retrieval processing section 15h of the server device 1 of the first embodiment.

This reference information generating unit 15j serves as a reference information extraction process arrangements which extracts the entire portion or one portion of the comment contents stored in the comment contents DB 12 for each of the chat rooms, and uses the comment contents as reference information given to each of the users.

(Processes of the Present System)

Next, a detailed explanation will be given of processes that are executed by using the present system having the above-mentioned arrangement. In addition to the basic processes, the comment contents storing process and the comment contents updating process of the first embodiment, these processes mainly include a reference information presenting process for presenting reference information used by the user for selecting a chat room.

(Reference Information Presenting Process)

The following description will discuss this reference information presenting process. When the user manually makes a request for reference information, this process is started, or this process is automatically started in predetermined synchronized timing. In the present embodiment, when the user selects a desired chat room so as to obtain the reference information thereof from the list of chat rooms in the initial screen of chats shown in the aforementioned FIG. 8, the reference information presenting process is started.

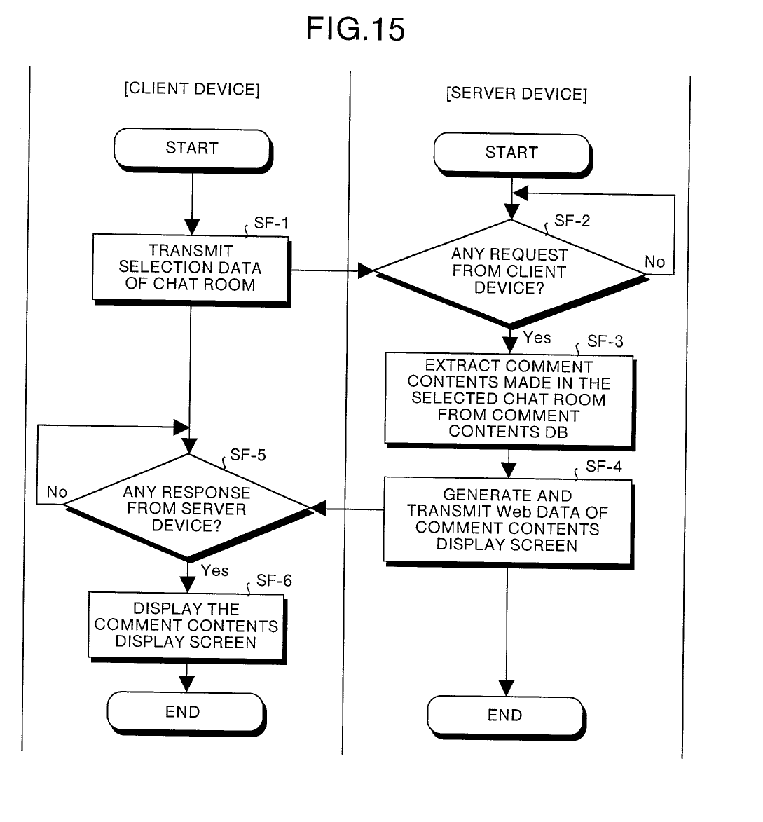

FIG. 15 shows a flow chart of this process. As shown in FIG. 15, when information for specifying the selected chat room (chat room ID, etc.) is transmitted to the server device 1 (step SF-1), the request interpreting section 15a of the server device 1 passes this information to the reference information generating unit 15j.

Then, the reference information generating unit 15jextracts the comment contents in the chat room specified by this information from the comment contents DB12 (step SF-2, SF-3). Then, it passes the comment contents to the visit processing section 15b, and the visit processing section 15b generates Web data of the comment contents display screen for displaying these comment contents, and transmits the resulting data to the client device 2 (step SF-4). Consequently, the comment contents display screen is displayed on the monitor 25 (step SF-5, SF-6). Thus, the reference information presenting process is completed.

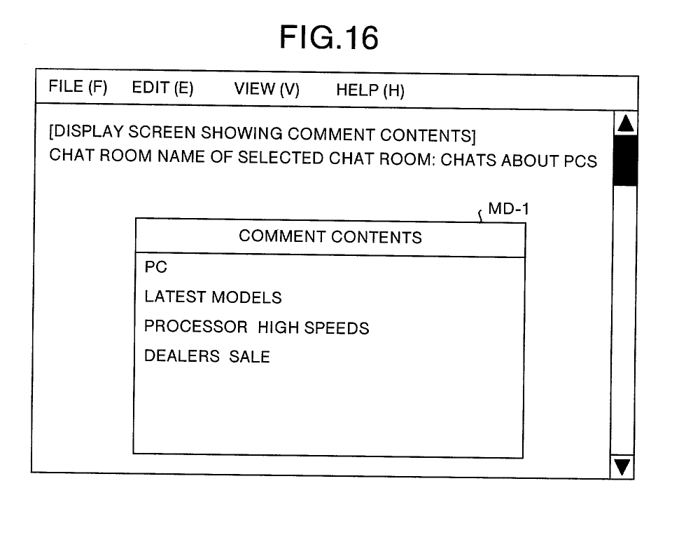

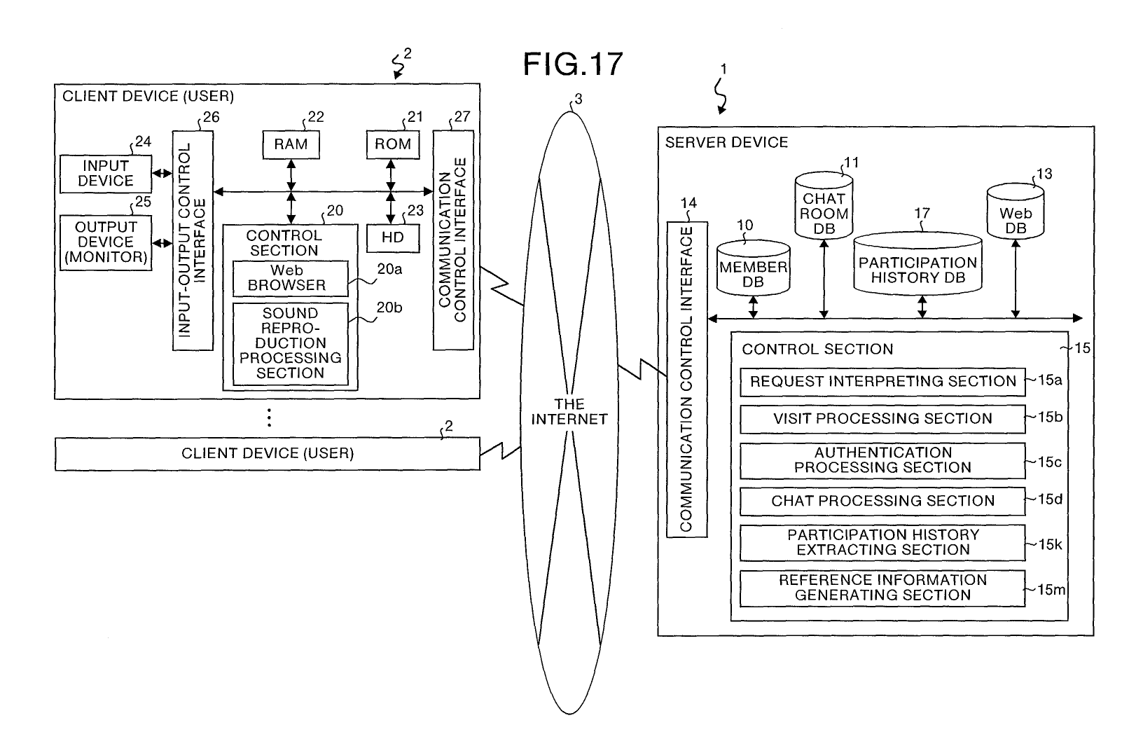

For example, as shown in FIG. 16, this screen displays the comment contents MD-1 given in the chat room selected by the user. Then, referring to this display, the user can make a determination as to whether or not he or she participates in this chat room.

Here, with respect to the comment contents to be extracted at the above-mentioned step SF-3, they are limited to those highly meaningful comment contents that have been language-analyzed in the language analyzing section 15f, and they are also limited to only the recent comment contents by the comment contents update processing section 15g, therefore, they are few in the number of data, thereby making it possible to reduce the system load, and to give highly effective reference information.

(Fourth Embodiment)

(Outline of the Entire System)

Next, an explanation will be given of a fourth embodiment. In the present embodiment, different from the foregoing embodiments, the comment contents in the past given in each chat room are not recorded, and reference information based upon URLs of chat rooms in which the user participated in the past is given.

However, with respect to constructions and processes not specifically explained, supposing that they are the same as those of the first embodiment, the description thereof is omitted. Moreover, the same constituent elements are indicated by the same names and reference numerals.

(System Construction—Server Device 1)

Next, an explanation will be given of the system construction for achieving such a chat environment. First, an explanation will be given of the construction of the server device 1. In FIG. 17, the server device 1 is provided with a reference history DB17 in place of the comment contents DB12 of the server device 1 of the first embodiment. Moreover, in place of the comment contents extraction processing section 15e, the language analyzing section 15f, the comment contents update processing section 15g and the retrieval processing section 15h, it is also provided with a participation history extracting section 15k and a reference information generating section 15m.

Among these, the participation history DB17 is a participation history data base which stores information for specifying chat rooms that each of the users has participated in for each of the users. Specific pieces of information to be stored in this participation history DB17 are the user ID of each of the users, URLs of chat rooms in which each of the users has participated and a time stamp indicating the time at which each of the URLs was stored, which are all made in association with each other.

Moreover, the participation history extracting section 15k serves as a participation history extraction process arrangements which extracts information for specifying chat rooms in which each of the users has participated.

Furthermore, the reference information generating section 15m serves as a reference information generating unit which generates reference information used as reference by each user upon selecting a chat room based upon information stored in the participation history DB17.

(System Construction—Client Device 2)

Moreover, in the present embodiment, a sound reproduction processing section 20b is installed in the control section 20 of the client device 2. This sound reproduction processing section 20b is used for outputting sound data transmitted from the server device 1, and constituted by, for example, plug-in software with respect to the Web browser 20a.

(Processes in the Present System)

Next, a detailed explanation will be given of processes that are executed by using the present system having the above-mentioned arrangement. In addition to the basic processes of the first embodiment, these processes mainly include a participation history storing process for storing the participation history and a reference information presenting process for presenting reference information to the user.

(Participation History Storing Process)

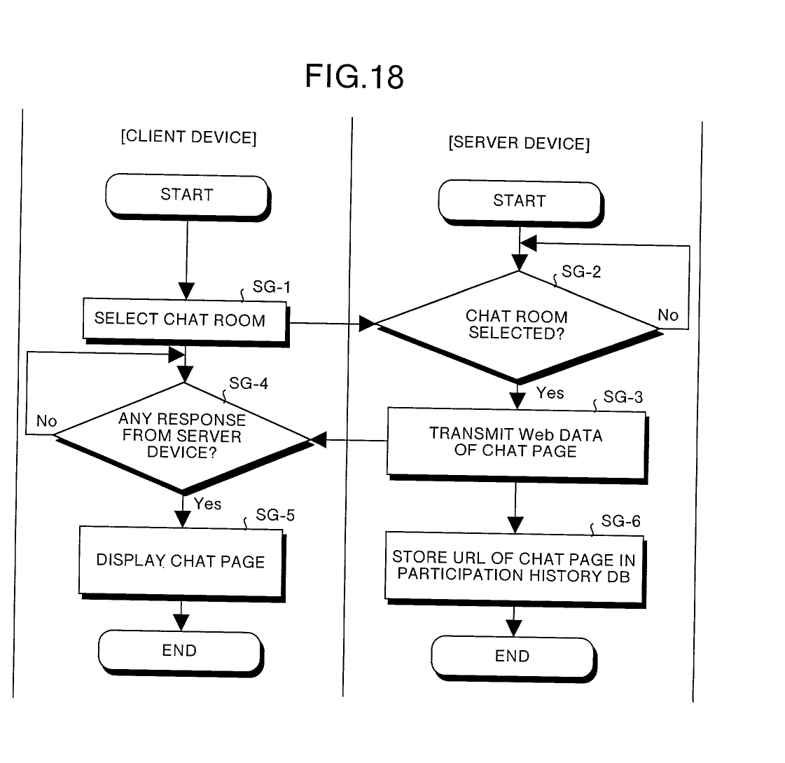

First, an explanation will be given of the participation history storing process. This process is automatically carried out every time the user participates in a chat room in the aforementioned basic processes of chats. FIG. 18 shows a flow chart of this process. As shown in FIG. 18, when the user selects a chat room in the initial screen of chats in the aforementioned FIG. 8, this fact is transmitted to the server device 1 (step SG-1).

Upon receipt of this (step SG-2), the server device 1 transmits the Web data of chat page of this chat room to the client device 2 (step SG-3). Consequently, the chat page is displayed on the monitor 25 (step SG-4, SG-5).

Moreover, when a chat room is selected as described above, this fact is transferred to the participation history extracting section 15k of the server device 1. Then, the participation history extracting section 15k stores the URL of the chat room selected by the user, together with the user ID of the user and a time stamp at that point of time obtained through a known method, in the participation history DB17. Thus, the participation history storing process is completed.

Here, in the participation history DB17, the number of storages of URLs per user is limited to a predetermined number of times (for example, 5 times), and only URLs corresponding to predetermined number of times at which storages of those URLs are most lately made are stored in the participation history DB17. Such an information storing process is achieved by, for example, allowing the memory structure to have an FIFO (First In First Out) format. Here, in this type of structure, the participation history DB17 and the participation history extracting section 15k serve as a participation number limit arrangements which limits information to be stored in the participation history DB17 only to those pieces of information corresponding a predetermined number of participation closest to that point of time.

(Reference Information Presenting Process)

Next, an explanation will be given of a reference information presenting process. This process is carried out by an instruction from the user, or automatically carried out in predetermined synchronized timing. In the present embodiment, upon generating Web data of the initial screen of chats in FIG. 8 explained in the basic processes of chats in the first embodiment, the retrieving process is automatically carried out, and the results thereof are outputted from the output device 25 through synthesized voice.

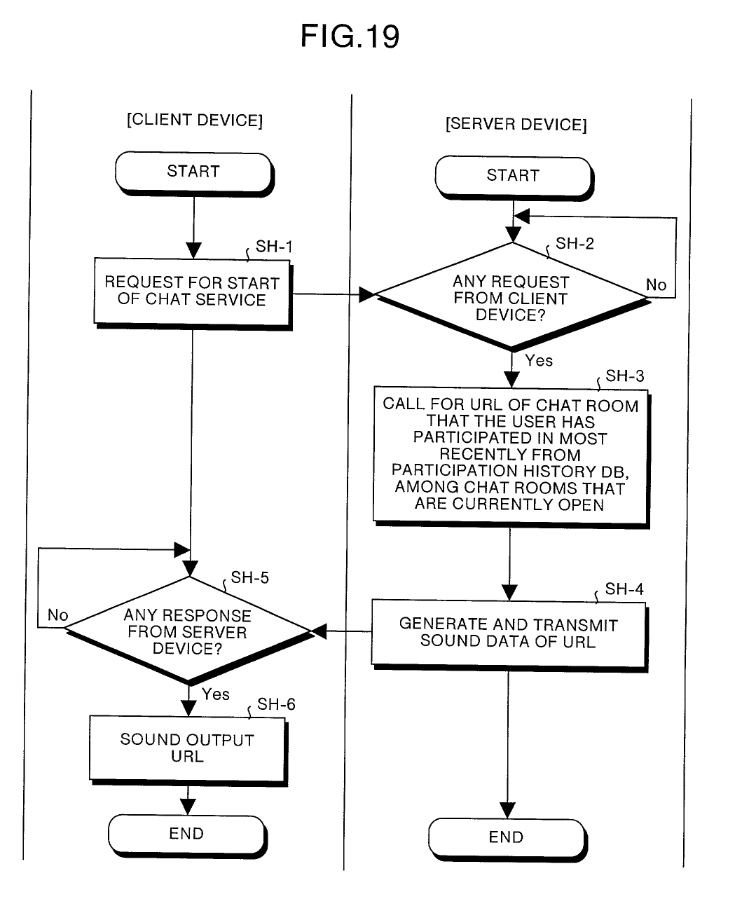

More specifically, when the user selects a chat service from the member private screen, the reference information presenting process is started. FIG. 19 shows a flow chart of this process. As shown in FIG. 19, when the user makes a request for the start of the chat service, this request is transmitted to the server device 1 (step SH-1). Upon receipt of this (step SH-2), the request interpreting section 15a of the server device 1 passes this request to the reference information generating section 15m. Then, the reference information generating section 15m calls for URLs corresponding to a predetermined number of times that are stored in association with the user ID of the user in question from the participation history DB17. Then, among the URLs thus called for, it calls for the URLs of the chat rooms that are currently open by reference to the chat room DB11. Then, among these URLs, one URL of the chat room most recently visited is called for by reference to the time stamp in the participation history DB17 (step SH-3).

Here, the reference information generating section 15mgenerates sound data used for sound-outputting the single URL that is finally called for, and transmits this sound data to the client device 2 (step SH-4). This sound data is transferred to the sound reproduction processing section 20b through the Web browser 20a of the client device 2, and sound-outputted by this sound reproduction processing section 20b (step SH-5, SH-6). For example, sound information, such as “Chat room suitable for you is now under construction. URL is . . . ”, is reproduced. Thus, reference information presenting process is completed.

Then, after listening to this sound information, the user is allowed to know the URL of a chat room in which he or she has participated before, and to confirm that this chat room is now open, thus, by inputting this URL in the Web browser 20a or the like, he or she is allowed to participate in this chat room.

Here, in the above-mentioned explanation, among the URLs stored in the participation history DB17, only one URL that relates to chat rooms being currently open and that has been visited by the user most recently is extracted. However, beside this method, various extracting methods may be proposed.

For example, the participation history extracting section 15k is simply allowed to store all the URLs of chat rooms that the user has participated in the past in the participation history DB17, and the reference information generating section 15m may extract all these URLs and present them as reference information.

Alternatively, in addition to URLs of all the chat rooms that have been visited in the past, the participation history extracting section 15k may store the number of participation in each chat room in the participation history DB17, and based upon the number of participation, the reference information generating section 15m may find the frequency of participation in each chat room, and supply one or a plurality of URLs of the chat rooms that have higher frequencies of participation to the user as reference information.

Alternatively, in order to enhance the effectiveness of reference information, URLs of a plurality of chat rooms that have been visited in the past are stored in the participation history DB17, and a weighting process is carried out on these URLs in a predetermined method so that one or a plurality of URLs that are highly important (fit in with the user's tastes) may be extracted and supplied as reference information.

With respect to the method for this weighting process, various types are suggested, and, for example, the participation history extracting section 15k stores the number of participation and participation time in each chat room in the participation history DB17, in addition to URLs of all the chat rooms that have been visited in the past. Then, the participation frequencies are found by the reference information generating section 15m as described above, and depending on the participation frequencies, predetermined points are given to the respective chat rooms (for example, 10 points for the greatest participation frequency, 9 points for the second greatest participation frequency, etc.) Moreover, depending on the participation time, predetermined points are given by the reference information generating section 15m to the respective chat rooms (for example, 10 points for the longest participation time, 9 points for the second longest participation time, etc.). Then, it is determined that the greater the sum of these points, the better the chat room fits in with the user's tastes.

(Fifth Embodiment)

(Outline of the Entire System)

Next, an explanation will be given of a fifth embodiment. In the present embodiment, different from the foregoing embodiments, reference information relating to the opening schedule of chat rooms is basically supplied.

However, with respect to constructions and processes not specifically explained, supposing that they are the same as those of the first embodiment, the description thereof is omitted. Moreover, the same constituent elements are indicated by the same names and reference numerals.

(System Construction—Server Device 1)

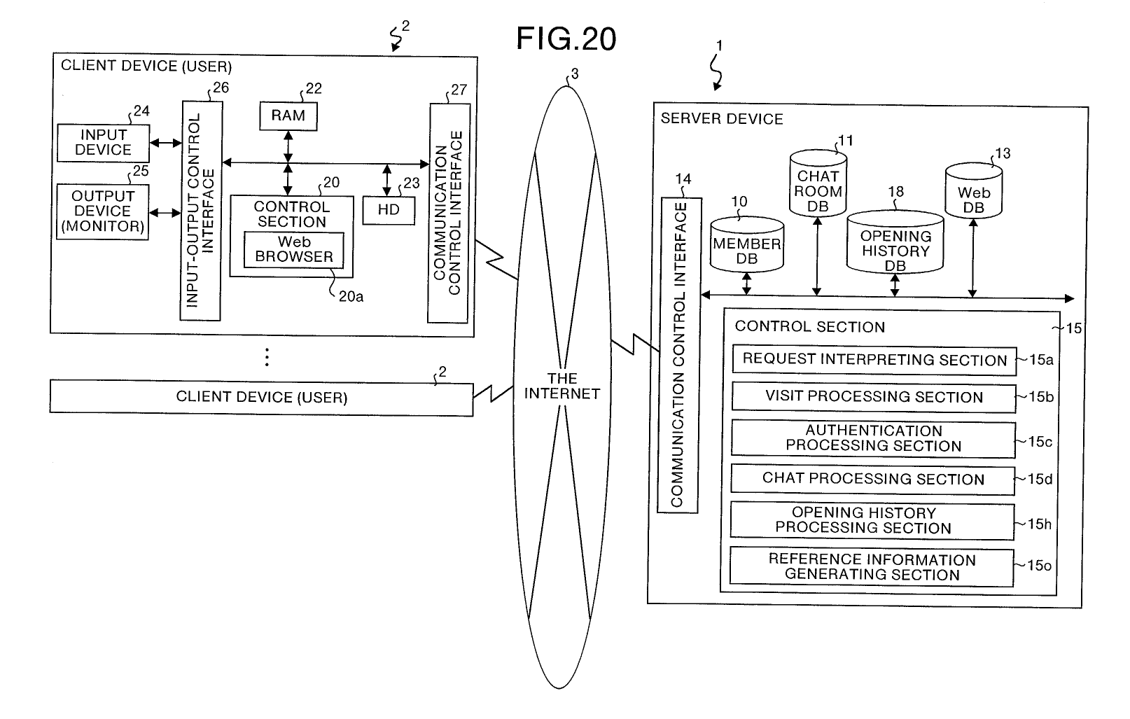

Next, an explanation will be given of the system construction for achieving such a chat environment. First, an explanation will be given of the construction of the server device 1. In FIG. 20, the server device 1 is provided with an opening history DB18 in place of the comment contents DB12 of the server device 1 of the first embodiment. Moreover, in place of the comment contents extraction processing section 15e, the language analyzing section 15f, the comment contents update processing section 15g and the retrieval processing section 15h, it is also provided with an opening history extracting section 15n and a reference information generating section 15o.

Among these, the opening history DB18 serves as an opening history data base which stores information relating to chat room opening history of chat rooms that are currently open for each of chat rooms. Specific pieces of information to be stored in this opening history DB18 are the chat room ID of each of the chat rooms, the chat room name of each of the chat rooms, URLs of the chat rooms and a time stamp indicating the time at which each of the chat rooms is opened, which are all made in association with each other.

Moreover, the opening history extracting section 15nserves as an opening history extraction process arrangements which extracts information relating to the opening history of chat rooms that are currently open.

Furthermore, the reference information generating section 15o serves as a reference information generating unit which generates reference information relating to time at which each of the chat rooms is opened based upon information stored in the opening history DB18.

(Processes in the Present System)

Next, a detailed explanation will be given of processes that are executed by using the present system having the above-mentioned arrangement. In addition to the basic processes of the first embodiment, these processes mainly include an opening history storing process for storing the opening history and a reference information presenting process for presenting reference information to the user.

(Opening History Storing Process)

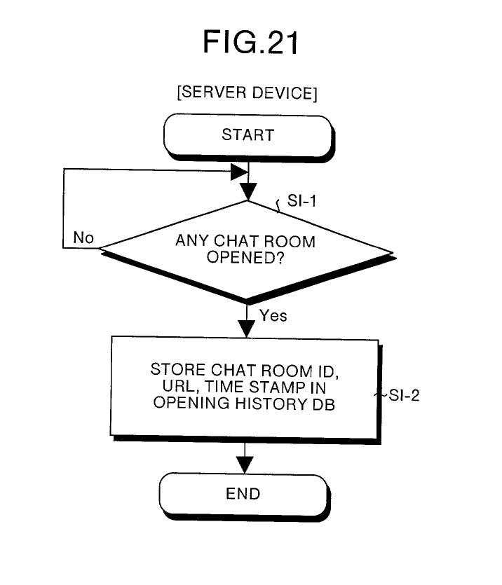

First, an explanation will be given of an opening history storing process. This process is automatically carried out every time a chat room is opened in the aforementioned basic processes of chats. FIG. 21 shows a flow chart of this process. As shown in FIG. 21, the opening history extracting section 15nof the server 1 monitors the presence or absence of an opening of any chat room (step S1-1), and when a chat room is opened, it stores the chat room ID, the chat room name and URL of this chat room and a time stamp at that point of time obtained in a proper method in the opening history DB18 (step S1-2). Moreover, at this time, in the case when the chat room ID, etc. have already been stored in the opening history DB18, only the time stamp is stored in association with this. Thus, the opening history storing process is completed.

(Reference Information Presenting Process)

Next, an explanation will be given of a reference information presenting process. This process is carried out by an instruction from the user given through a predetermined method, or carried out in predetermined automatic synchronized timing. In the present embodiment, upon generating Web data of the initial screen of chats in FIG. 8 explained in the basic processes of chats in the first embodiment, the retrieving process is automatically carried out, and the results thereof are reflected to the initial screen of chats.

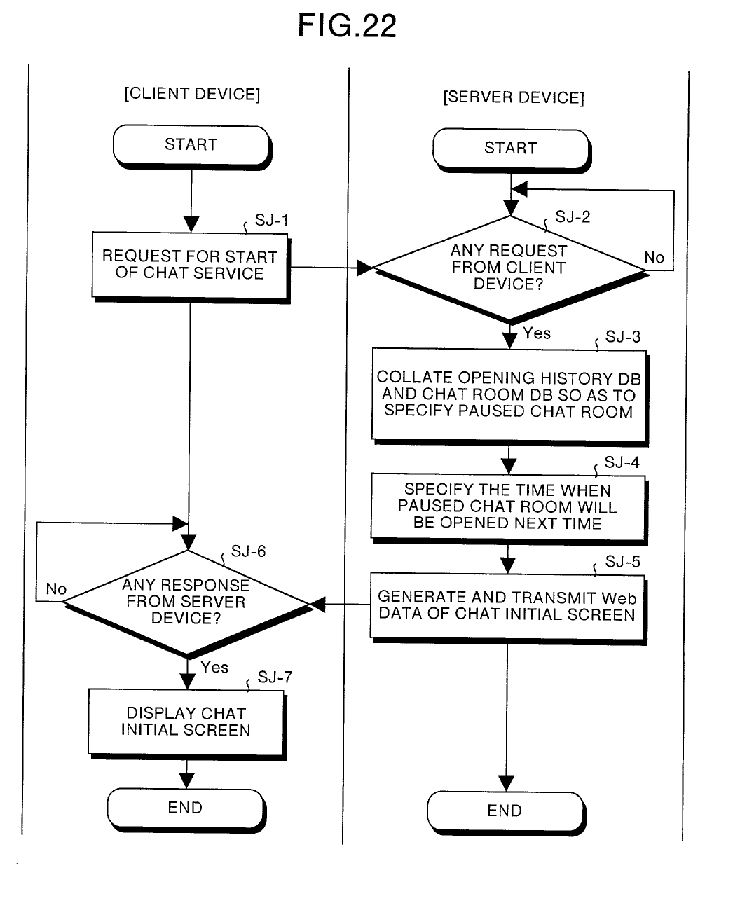

More specifically, when the user selects a chat service from the member private screen, the reference information presenting process is started. FIG. 22 shows a flow chart of this process. As shown in FIG. 22, when the user makes a request for the start of the chat service, this request is transmitted to the server device 1 (step SJ-1). Upon receipt of this (step SJ-2), the request interpreting section 15a of the server device 1 passes this request to the reference information generating section 15o. Then, based upon the chat room IDs stored in the opening history DB18 and the chat room IDs stored in chat room DB11, the reference information generating section 15ospecifies chat room IDs of chat rooms that have been opened before and that are not open at that point of time (hereinafter, referred to as paused chat rooms)(step SJ-3).

Then, the reference information generating section 15ocalls for time stamps related to this specified chat room ID from the opening history DB18, and based upon these time stamps, it specifies the time at which the paused chat room is next opened (scheduled opening time)(step SJ-4). This specifying process can be carried out in various methods including known statistical methods, etc., for example, in the case when a plurality of time stamps of each of the paused chat rooms are stored, based upon the duplicated times of these time stamps, the day of the week and the time on and at which the chat room is most frequently opened are specified.

More specifically, for example, in the case when time stamps of a certain paused chat room, such as “2000. 3. 1. 20:00 (numeric values separated by dots respectively showing, Century, Month, Date, Time)”, “2000. 3. 8. 20:00”, “2000. 3. 15. 20:00”, are stored, it is specified that this paused chat room will be opened at “2000. 3. 22. 20:00” (here, since chat rooms are seldom opened at the completely same time, the time width of the time stamp may be widened by a predetermined time, or time stamps that are statistically heterogeneous may be excluded.)

Then, the reference information generating section 15otransfers the scheduled opening time of the paused chat room, thus specified, to the visit processing section 15b. The visit processing section 15b calls for the chat room name and URL of the paused chat room from the opening history DB18, and generates the initial screen of chats including the scheduled opening time, chat room name and URL, and transmits this to the client device 2 (step SJ-5). Consequently, the initial screen of chats is displayed on the monitor 25 (step SJ-6, SJ-7). Thus, the reference information presenting process is completed.

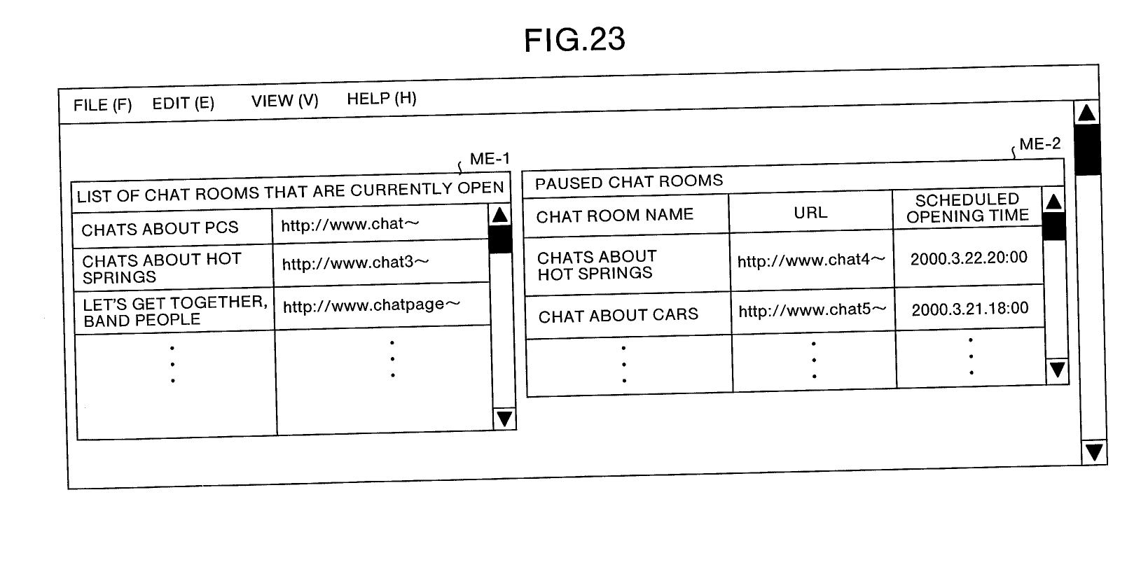

For example, FIG. 23 shows this screen. In the same manner as the initial screen of chats in the first embodiment, the list ME-1 of chat rooms that are currently open is displayed, and a list ME-2 including the chat room name, URL and scheduled opening time of the paused chat room is displayed. Referring to the scheduled opening time, the user is allowed to confirm the time at which the paused chat room is opened, thus, he or she can wait until his or her desired chat room has been opened, by utilizing other services, or can once log off the system, and again log on the system at the scheduled opening time to join the chat room.

While embodiments of the present invention has been shown and described in detail, the foregoing description is in all aspects illustrative and not restrictive. It is therefore understood that numerous other modifications and variations can be devised without departing from the scope of the invention.

For example, the arrangements as described in the first to fifth embodiments may be mutually combined with each other.

Moreover, among the respective processes described in the above-mentioned embodiments, all or one portion of the processes that are explained as being automatically carried out may be manually carried out, or all or one portion of the processes that are explained as being manually carried out may be automatically carried out by using a known method.

Furthermore, with respect to processing sequence, controlling sequence, specific names and information including parameters such as various registering data and retrieval conditions that are shown in the above description and drawings, they can be altered desirably, unless otherwise described. In particular, the drawings showing the structural examples of data are conceptual drawings that indicate data items and their corresponding relationships and that do not limit specific data contents and formats, therefore, the data contents and formats may be modified desirably.

According to the present invention, the contents of a comment in each chat room are extracted, and stored for each of the chat rooms or for each of the users, and based upon the contents of the comment, reference information that is used as reference when each user makes a selection from chat rooms is generated, and informed to each of the users. Therefore, the user is allowed to select a chat room based upon the contents of comments that have been made in the chat room, and consequently to easily make the selection quickly.

According to the invention, the language analysis is carried out on the contents of the comment, and only those contents of comments that are highly meaningful are stored in the comment contents storing unit. Therefore, the reference information can be generated in a manner so as to exclude information that is not used as reference upon determining the contents of a chat room, such as the contents of comments only including sound effects or facial characters, etc. With this arrangement, it is possible to reduce the number of data to be stored or retrieved, to reduce the system load, and consequently to carry out an effective retrieving operation quickly.

According to the invention, only those contents of a comment that have been made within a predetermined time closest to that point of time are stored in the comment contents storing unit. Therefore, when reference information is generated, it is possible to exclude those pieces of information that are not used as reference in determining the contents of a chat room because a certain period of time has elapsed since the information was given. Therefore, it becomes possible to reduce the number of data to be stored or retrieved, to reduce the system load, and consequently to carry out an effective retrieving operation quickly.

According to the invention, based upon a key word transmitted from each of the users through the information terminal device, retrieval is carried out on the contents of comments stored in the comment contents storing unit. Therefore, the user is allowed to carry out a keyword retrieving operation with respect to the contents of previous comments so that it is possible for the users to easily select a chat room or the like that fits in with his or her tastes quickly.

According to the invention, based upon the contents of past comments made by the users, retrieval is carried out on the contents of comments stored in the comment contents storing unit, and the results of this retrieval are given to the user as reference information. Therefore, the user is allowed to automatically select a chat room or the like that fits in with his or her contents of comments. In particular, in this case, the contents of past comments of each user are automatically accumulated and used as a keyword, therefore, a chat room which fits in with the user's tastes that the user himself or herself has not been aware of might be selected, and the user becomes free from time consuming tasks for inputting a keyword.

According to the invention, one portion or the entire portion of the contents of a comment stored for each of chat rooms by the comment contents storing unit is extracted, and given to the user as reference information. Therefore, without the necessity of logging in a chat room, the user can view the contents thereof so that he or she is allowed to easily select a chat room or the like that fits in with his or her tastes quickly.

According to the invention, information used for identifying a chat room to which the user has joined is stored for each of the users, and based upon this information, reference information is generated, and given to the user. Therefore, even when the user does not remember a chat room he or she has joined before, he or she can easily join this chat room.

According to the invention, information used for identifying a chat room to which the user has joined is limited to those pieces of information that correspond to a predetermined number of participation closest to that point of time. Therefore, reference information is generated while excluding those pieces of information that are not used as reference for determining the contents of a chat room because a certain period of time has elapsed since the last participation. With this arrangement, it becomes possible to reduce the number of data to be stored or retrieved, to reduce the system load, and consequently to carry out an effective retrieving operation quickly.

According to the invention, information used for specifying a chat room that a user has participated in is limited to those pieces of information of a chat room in which the user has participated not less than a predetermined frequency. Therefore, it is possible to generate reference information by excluding those pieces of information related to chat rooms that the user has participated in only once, or seldom participated in. Thus, it becomes possible to reduce the number of data to be stored or retrieved, to reduce the system load, and consequently to carry out an effective retrieving operation quickly.

According to the invention, a predetermined weighting process is carried out on the reference information, and based upon the results of the weighting process, the reference information to be informed to the user is limited. Therefore, among pieces of information used for identifying a chat room in which the user has participated, those pieces of information that are of great importance for the user are preferentially presented, thus, it is possible to enhance the validity of the reference information.

According to the invention, only information relating to chats that are open at that point of time are given to the user as reference information. Therefore, even in the case when a chat room is dynamically formed or frequently shifted, it is possible to present effective reference information at that point of time.

According to the invention, information related to a chat room opening history that has been opened is stored for each of chat rooms, and based upon this opening history, reference information relating to time at which a chat room is opened is generated, and this is given to the user. Therefore, in addition to information related to the past chat rooms, information relating to chat rooms that have not been opened at that point of time can be given so that the user is allowed to easily determine a plan for participating in the chat room or the like quickly.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A chat system comprising:
a plurality of information terminal devices respecting associated with plural chat users, and
a chat information processing device connected to the information terminal devices through a computerized network for processing information relating to computerized chats,
wherein said chat information processing device includes:
a comment contents extraction process arrangements for extracting the contents of a comment transmitted from said information terminal devices in each of a plurality of chat rooms;
a comment contents data base for storing the contents of a comment extracted by the comment contents extraction process arrangements with relating to each of the chat rooms in which the comment has been made or with relating to each of the users that has made the comment;
a reference information generating arrangements for generating reference information based upon the contents of the comment stored in the comment contents data base for use as reference information when said user selects a chat room; and
an inform arrangements for informing said information terminal device of the reference information generated by the reference information generating arrangements.

2. The chat system according to claim 1, wherein,
the chat information processing device is a chat server, and
the computerized network is the Internet.

3. A chat information processing device for processing information relating to computerized chats when connected to a plurality of information terminal devices respecting associated with plural chat users through a computerized network, comprising:
a comment contents extraction process arrangements for extracting the contents of a comment transmitted from said information terminal devices in each of a plurality of chat rooms;
a comment contents data base for storing the contents of a comment extracted by the comment contents extraction process arrangements with relating to each of the chat rooms in which the comment has been made or with relating to each of the users that has made the comment;
a reference information generating arrangements for generating reference information based upon the contents of the comment stored in the comment contents data base for use as reference information when said user selects a chat room; and
an inform arrangements for informing said information terminal device of the reference information generated by the reference information generating arrangements.

4. The chat information processing device according to claim 3, further comprising:
a comment contents description-limit arrangements for performing a language analysis on the contents of the comment extracted by the comment contents extraction process arrangements so that the contents of comment to be stored in the comment contents data base are limited only to those meaningful contents.

5. The chat information processing device according to claim 3, further comprising:
a comment contents time-limit arrangements for limiting the contents of the comment to be stored in the comment contents data base to those contents of the comment that have been made within a predetermined time closest to that point of time.

6. The chat information processing device according to claim 3, wherein,
the reference information generating arrangements comprises:
a retrieve process arrangements for performing retrieval on the contents of the comment stored in the comment contents data base based upon a key word transmitted from said information terminal device, and which allows the results of the retrieval to form the reference information.

7. The chat information processing device according to claim 3, wherein,
the reference information generating arrangements comprises:
a second process arrangements for performing retrieval on the contents of the comment stored in the comment contents data base, based upon the contents of other comments stored in the comment contents data base, and allows the results of the retrieval to form the reference information.

8. The chat information processing device according to claim 3, wherein,
the reference information generating arrangements comprises:
a reference information extraction process arrangements for extracting the contents of the comment stored in the comment contents data base, and allows the results of the extracting to form the reference information.

9. The chat information processing device according to claim 3, wherein,
the chat information processing device is a chat server, and
the computerized network is the Internet.

10. A chat information processing device for processing information relating to computerized chats when connected to a plurality of information terminal devices respecting associated with plural chat users through a computerized network, comprising:
a participation history extraction process arrangements for extracting information used for identifying a chat room to which said user has joined;
a participation history data base for storing information extracted by the participation history extraction process arrangements with relating to each of the users who has joined to the chat room;
a reference information generating arrangements for generating reference information based upon the information stored in the participation history data base for use as reference information when said user selects a chat room; and
an inform arrangements for informing said information terminal device of the reference information generated by the reference information generating arrangements.

11. The chat information processing device according to claim 10, further comprising:
a participation number limit arrangements for limiting information to be stored in the participation history data base only to those information that correspond to a predetermined number of participation closest to that point of time.

12. The chat information processing device according to claim 10, wherein,
the reference information generating arrangements calculates the frequency of participation of each of the users to each chat room, and limits the reference information to be informed to said information terminal device based upon the frequency of participation.

13. The chat information processing device according to claim 10, wherein,
the reference information generating arrangements carries out a predetermined weighting process on the reference information, and limits the reference information based upon the results of the weighting process only to those information that is informed to said user.

14. The chat information processing device according to claim 10, wherein,
the reference information generating arrangements uses only information relating to chats that are open at that point of time as reference information.

15. The chat information processing device according to claim 10, wherein,
the chat information processing device is a chat server, and
the computerized network is the Internet.

16. A chat information processing device for processing information relating to computerized chats, which is connected to an information terminal device of each of chat users through a computerized network, comprising:
an opening history extraction process arrangements for extracting information relating to the opening history of a chat room;
an opening history data base for storing information extracted by the opening history extraction process arrangements for each of chat rooms;
a reference information generating arrangements for generating reference information relating to time at which said chat room is opened, based upon information stored in the opening history data base; and
an inform arrangements for informing said information terminal device of the reference information generated by the reference information generating arrangements.

17. A chat information processing method for processing information relating to computerized chats by using a chat information processing device which is connected to an information terminal device of each of chat users through a computerized network comprising:
(a) extracting the contents of a comment transmitted from said information terminal devices in each of a plurality of chat rooms;
(b) storing the contents of a comment extracted by the extracting step (a) in said chat information processing device with relating to each of the chat rooms in which the comment has been made or with relating to each of the users that has made the comment;
(c) generating reference information based upon the contents of the comment stored at the storing step (b) for use as reference information when said user selects a chat room; and
(d) informing said information terminal device of the reference information generated by the generating step(c).

18. The chat information processing method according to claim 17, wherein,
the chat information processing device is a chat server, and
the computerized network is the Internet.

19. A chat information processing method for processing information relating to computerized chats by using a chat information processing device which is connected to an information terminal device of each of chat users through a computerized network comprising:
(a) extracting information used for identifying a chat room to which said user has joined;
(b) storing information extracted by the extracting step (a) in said chat information processing device with relating to each of the users who has joined to the chat room;
(c) generating reference information based upon the information stored at the storing step (b) for use as reference information when said user selects a chat room; and
(d) informing said information terminal device of the reference information generated by the generating step (c).

20. A chat information processing method for processing information relating to computerized chats by using a chat information processing device which is connected to an information terminal device of each of chat users through a computerized network comprising:
(a) extracting information relating to the opening history of a chat room;
(b) storing information extracted by the extracting step (a) in said chat information processing device for each of chat rooms;
(c) generating reference information relating to time at which said chat room is opened, based upon information stored in the storing step (b); and
(d) informing said information terminal device of the reference information generated by the generating step(c).

21. A computer-readable recording medium comprising wherein a computer program thereon, the computer program for a computer to execute chat information processing methods according to claim 17.

22. A computer-readable recording medium comprising wherein a computer program thereon, the computer program for a computer to execute chat information processing methods according to claim 19.

23. A computer-readable recording medium comprising wherein a computer program thereon, the computer program for a computer to execute chat information processing methods according to claim 20.
